(19) United States
(12) Patent Application Publication
(10) Pub. No.: US 2016/0094608 A1
(43) Pub. Date: Mar. 31, 2016

(54) Proactive TCP Connection Stall Recovery for HTTP Streaming Content Requests

(71) Applicant: QUALCOMM Incorporated, San Diego, CA (US)

(72) Inventors: Jay Kumar Sundararajan, San Diego, CA (US); Yinian Mao, San Diego, CA (US); Lorenz Christoph Minder, Evanston, IL (US); Arvind Subramanian Krishna, San Diego, CA (US); Rashmi Keshava Iyengar, San Diego, CA (US); Sha Hua, San Diego, CA (US)

(21) Appl. No.: 14/551,457

(22) Filed: Nov. 24, 2014

Related U.S. Application Data
(60) Provisional application No. 62/057,701, filed on Sep. 30, 2014.

(51) Int. Cl. H04L 29/06; H04L 12/707

(52) U.S. Cl. CPC H04L 65/80; H04L 65/1083; H04L 45/22

(57) ABSTRACT

Methods, devices, systems, and non-transitory computer-readable storage media for improving the reception of data at a computing device by proactively utilizing new TCP connections in response to identifying that TCP connections have stalled. In an embodiment, a processor of the computing device may perform operations including monitoring a status of requests via a plurality of TCP connections, identifying a stalled TCP connection having a missing request based on the monitoring, wherein the stalled TCP connection is configured to utilize a first network interface and access a first data source, evaluating other TCP connections to determine whether the other TCP connections stall using the first network interface or when accessing the first data source; identifying a second network interface and a second data source based on the evaluating, and reissuing the missing request with a new TCP connection configured to use the second network interface and access the second data source.

### RELATED APPLICATIONS

This application claims the benefit of priority to U.S. Provisional Application No. 62/057,701 entitled “Proactive TCP Connection Stall Recovery for HTTP Streaming Content Requests,” filed Sep. 30, 2014, the entire contents of which are hereby incorporated by reference.

### BACKGROUND

Video streaming applications often use one or more Transmission Control Protocol (TCP) connections to download media content from the Internet using data requests, such as HTTP requests. For example, some computing devices configured with Transport Accelerator (TA) functionalities may split HTTP “GET” requests for data objects into multiple HTTP GET sub-requests for different byte ranges of the same object (or “chunks”). Each request (or sub-request) for a chunk (e.g., a chunk request) may be typically transmitted over a different TCP connection so that the bytes corresponding to the requested range of the chunk are downloaded over that different TCP connection. The TA functionalities may reorder the bytes received via requests and hand the reordered bytes to the layer above, such as an application layer. In some cases, bytes may be delivered to the layer above even before a request has been completed (e.g., before all chunks have arrived), as long as a contiguous sequence of bytes in order is available.

TCP connections (and thus data requests) may stall, causing long delays in completing data requests on stalled TCP connections. For example, a stall in the flow of streaming content may result in poor user experience due to video playback interruptions. Such stalling of TCP connections may be caused for various reasons. For example, a TCP connection may stall in the middle of the download due to network congestion. As another example, stalling may occur with TCP connections over cellular networks due to user equipment moving between cell zones. Stalling of TCP connections may also be the result of link-layer errors, routing problems, or even configuration issues in a proxy server or network access translation (NAT) functionality or firewall within a network.

To address such problems, conventional stall recovery mechanisms exist. For example, the TCP itself may attempt to recover from error conditions through timeouts and retransmissions. For example, conventional TCP mechanisms attempt to recover from such stalls by retransmitting unacknowledged segments starting with the oldest. Further, conventional mechanisms may merely re-issue requests on the same network interface and/or for the same data source as experienced by the stalled TCP connections. For example, although a user device may utilize multiple “networking options” to fetch media content (e.g., multiple network interfaces or multiple data servers), TCP recovery mechanisms in response to stalled TCP connections may only attempt retransmissions using the same network interface and the same server as the stalled TCP connections.

Such recovery mechanisms may not be sufficient in some situations, such as with reference to video streaming applications. For example, in cellular networks, uplink packets (e.g., TCP ACKs) of one or more TCP connections may get dropped for several tens of seconds, causing a server to timeout and unnecessarily retransmit a TCP segment that has already been received by a requesting device. Sometimes this may affect all the TCP connections due to a degradation of the link as a whole, and at other times it may affect only one or a subset of the ongoing TCP connections if the problem is not due to link issues but instead due to other reasons, such as server or firewall issues. When a cellular connection is lost, existing TCP mechanisms cannot recover since either acknowledgements (ACKs) or retransmitted packets may not be delivered successfully. TCP may not recover from such a condition by itself In particular, conventional recovery mechanisms may be inadequate for some video streaming applications. As another example, uni-directional or bi-directional packet flows of a specific TCP connection may get interrupted for several seconds (e.g., ten seconds, etc.) while other TCP connections proceed without interruption, causing data to be received out-of-order.

Further, existing TCP mechanisms do not properly handle scenarios that involve multiple TCP connections downloading a particular media file. In particular, although lost data requests of a single TCP connection may be retransmitted in order (e.g., older first), when a plurality of TCP connections that are downloading portions of the same video stream stall (or otherwise experience packet loss), retransmissions of missed data packets may not occur in sequence order across the TCP connections. When multiple packets are lost, it is important to recover the lost packets in sequence order to prevent interruptions in video playback. There is no mechanism within TCP to ensure that retransmissions occur in sequence order across the TCP connections

### SUMMARY

Various embodiments provide methods, devices, systems, and non-transitory process-readable storage media for improving the reception of data at a computing device (e.g., streaming video media) by proactively utilizing new TCP connections in response to identifying that other TCP connections have stalled.

An embodiment method executed by a processor of a computing device may include operations for monitoring a status of requests via a plurality of TCP connections, identifying a stalled TCP connection having a missing request based on the monitoring, wherein the stalled TCP connection may be configured to utilize a first network interface and access a first data source, evaluating one or more other TCP connections to determine whether the one or more other TCP connections stall when using the first network interface or when accessing the first data source, identifying a second network interface and a second data source based on the evaluating, and reissuing the missing request with a new TCP connection configured to use the second network interface and access the second data source.

In some embodiments, identifying the stalled TCP connection having the missing request based on the monitoring may include identifying a current TCP connection as stalled and a request of the current TCP connection as missing based on one or more of determining a first time to setup for the current TCP connection is greater than a first threshold, determining a second time since a most recent successful reception on the current TCP connection is greater than a second threshold, determining a throughput for the current TCP connection is less than a third threshold, determining a roundtrip time for the current TCP connection is greater than a fourth threshold, determining an estimate of a congestion window used by the current TCP connection is greater than a fifth threshold, or determining a lower layer recovery mechanism failed for the current TCP connection. In some embodiments, identifying the stalled TCP connection having the missing request based on the monitoring may include identifying a current TCP connection as stalled and a request of the current TCP connection as missing based on one or more of determining a first download rate for the current TCP connection is less than a second dynamic threshold calculated based on a fair-share of an estimated available line rate for a first set of TCP connections of the plurality of TCP connections also using the first network interface, or determining a second download rate for the current TCP connection is less than a third dynamic threshold calculated based on a fair-share of an estimated available line rate for a second set of TCP connections of the plurality of TCP connections also accessing the first data source.

In some embodiments, evaluating the one or more other TCP connections to determine whether the one or more other TCP connections stall when using the first network interface or when accessing the first data source may include identifying the one or more other TCP connections using the first network interface, determining that the identified one or more other TCP connections are successful using the first network interface, and identifying the second network interface to be the same as the first network interface in response to determining the identified one or more other TCP connections are successful using the first network interface. In some embodiments, evaluating the one or more other TCP connections to determine whether the one or more other TCP connections stall when using the first network interface or when accessing the first data source may include identifying the one or more other TCP connections using the first network interface, determining that the identified one or more other TCP connections are not successful using the first network interface, and identifying the second network interface as a network interface different from the first network interface in response to determining the identified one or more other TCP connections are not successful using the first network interface.

In some embodiments, evaluating the one or more other TCP connections to determine whether the one or more other TCP connections stall when using the first network interface or when accessing the first data source may include identifying the one or more other TCP connections accessing the first data source, determining that the identified one or more other TCP connections are successful accessing the first data source, and identifying the second data source to be the same as the first data source in response to determining the identified one or more other TCP connections are successful accessing the first data source. In some embodiments, evaluating the one or more other TCP connections to determine whether the one or more other TCP connections stall when using the first network interface or when accessing the first data source may include identifying the one or more other TCP connections accessing the first data source, determining that the identified one or more other TCP connections are not successful accessing the first data source, and identifying the second data source as a data source different from the first data source in response to determining the identified one or more other TCP connections are not successful accessing the first data source.

In some embodiments, the method may further include determining whether the one or more other TCP connections are successful accessing the second data source using the second network interface, and maintaining the stalled TCP connection in response to determining that the one or more other TCP connections are not successful accessing the second data source using the second network interface. In some embodiments, the method may further include determining whether the one or more other TCP connections are successful accessing the second data source using the second network interface, in which reissuing the missing request with the new TCP connection configured to use the second network interface and access the second data source may include reissuing the missing request with the new TCP connection in response to determining that the one or more other TCP connections are successful accessing the second data source using the second network interface. In some embodiments, the reissued missing request only requests data identified in the missing request that was not received. In some embodiments, the method may further include generating an ordered list of stalled TCP connections with missing requests based on a predefined criteria, and wherein reissuing the missing request with the new TCP connection configured to use the second network interface and access the second data source may include reissuing each of the missing requests on new TCP connections based on the generated ordered list.

In some embodiments, the method may further include cancelling the stalled TCP connection in response to reissuing the missing request with the new TCP connection. In some embodiments, cancelling the stalled TCP connection in response to reissuing the missing request with the new TCP connection may include determining whether the missing request is completed via the stalled TCP connection before being completed via the new TCP connection, and cancelling the stalled TCP connection in response to determining the missing request is completed via the new TCP connection before being completed via the stalled TCP connection.

In some embodiments, the first network interface may be different than the second network interface. In some embodiments, the first network interface may be the same as the second network interface. In some embodiments, the first data source may be different than the second data source. In some embodiments, the first data source may be the same as the second data source.

In some embodiments, wherein reissuing the missing request with the new TCP connection configured to use the second network interface and access the second data source may include determining whether a reordering buffer occupancy exceeds an occupancy threshold, and reissuing the missing request with the new TCP connection in response to determining that the reordering buffer occupancy exceeds the occupancy threshold. In some embodiments, reissuing the missing request with the new TCP connection configured to use the second network interface and access the second data source may include determining whether a total incoming data rate exceeds a delivery rate to an application by a specified threshold for a specified time duration, and reissuing the missing request with the new TCP connection in response to determining that the total incoming data rate exceeds the delivery rate to the application by the specified threshold for the specified time duration.

Further embodiments include various computing devices configured with processor-executable instructions for performing operations of the methods described above. Further embodiments include non-transitory computer-readable (or processor-readable) media on which are stored processor-executable instructions configured to cause processors to perform operations of the methods described above. Further embodiments include a communication system including a computing device configured with processor-executable instructions to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system diagram of a communication system including a computing device and a plurality of data sources.

FIG. 2A is a component block diagram illustrating exemplary modules configured to be executed by a processor of a computing device suitable for use in some embodiments.

FIGS. 2B-2C are diagrams illustrating exemplary pseudocode that may be performed by a stall detection module executed by a computing device according to some embodiments.

FIG. 2D is a diagram illustrating exemplary pseudocode that may be performed by a retry module executed by a computing device according to some embodiments.

FIG. 2E is a diagram illustrating a table of exemplary parameters for configuring a computing device to detect stalled TCP connections and reissue requests on new TCP connections according to some embodiments.

FIGS. 3A-3B are process flow diagrams illustrating embodiment methods for a computing device to reissue requests (e.g., HTTP requests) of stalled TCP connections on new TCP connections configured based on data related to other TCP connections utilized by the computing device.

FIG. 4 is a process flow diagram illustrating an embodiment method for a computing device to reissue requests (e.g., HTTP requests) of stalled TCP connections on new TCP connections configured based on data related to other TCP connections utilized by the computing device and in an ordered manner.

FIG. 5 is a process flow diagram illustrating an embodiment method for a computing device to cancel stalled TCP connections based on completion of requests by new TCP connections.

FIG. 6 is a process flow diagram illustrating an embodiment method for a computing device to reissue requests (e.g., HTTP requests) of TCP connections identified as stalled based on static thresholds on new TCP connections configured based on data related to other TCP connections utilized by the computing device.

FIG. 7 is a process flow diagram illustrating an embodiment method for a computing device to reissue requests (e.g., HTTP requests) of TCP connections identified as stalled based on dynamic information on new TCP connections configured based on data related to other TCP connections utilized by the computing device.

FIG. 8 is a process flow diagram illustrating an embodiment method for a computing device to reissue requests (e.g., HTTP requests) of TCP connections based on reordering buffer occupancy and/or delivery rates to applications.

FIG. 9 is a component block diagram of a computing device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile computing device” or “mobile device” or “computing device” are used herein to refer to any one or all of cellular telephones, smartphones, web-pads, tablet computers, Internet enabled cellular telephones, Wi-Fi® enabled electronic devices, personal data assistants (PDA's), laptop computers, personal computers, and similar electronic devices equipped with at least a processor. In various embodiments, such devices may be configured with various network interfaces for communicating with other devices via wide area networks (WAN), such as the Internet. For example, a computing device may include a network transceiver to establish a wide area network (WAN) connection (e.g., Long Term Evolution (LTE), 3G, or 4G cellular network connection, etc.) and/or local area network (LAN) connection (e.g., Wi-Fi® LAN connection, etc.).

The term “data source” is used to refer to any computing device capable of establishing TCP connections with other devices via a network, such as a data or web server configured to handle HTTP requests from user computing devices. For example, a data source may be a master exchange server, a web server, a mail server, a document server, and/or a personal or mobile computing device configured with software to execute server functions (e.g., a “light server”). A data source may be a dedicated computing device or a computing device including a data source module (e.g., running an application which may cause the computing device to operate as a server). A data source module (or server application) may be a full function server module, or a light or secondary server module (e.g., light or secondary server application) that is configured to provide various services to various devices, such as databases on computing devices. A light server or secondary server may be a slimmed-down version of server type functionality that can be implemented on a personal or mobile computing device, such as a smart phone, thereby enabling it to function as an Internet server (e.g., an enterprise e-mail server) to a limited extent, such as necessary to provide the functionality described herein.

The various embodiments provide methods, devices, systems, and non-transitory process-readable storage media for improving the reception of data at a computing device (e.g., streaming video media) by proactively utilizing new TCP connections in response to identifying that other TCP connections have stalled. The computing device (e.g., a smartphone, laptop, personal computer, etc.) may be capable of establishing various TCP connections to download data from wide area network (WAN) data sources using various networking interfaces. The computing device may monitor the status, conditions, and/or progress of established (or active) TCP connections and detect when particular TCP connections have stalled, such as TCP connections that are not receiving a predefined amount of data for a predefined period. In response to determining that a TCP connection has stalled, the computing device may identify requests (or requested data) that have stalled or not completed (i.e., requests for data have not been fully received) due to the stalled TCP connection, and may re-issue those requests on a new or different TCP connection. The incomplete requests of stalled TCP connections are referred to herein as “missing requests”.

The computing device may configure and use new TCP connections for re-issuing missing requests of stalled TCP connections based on the conditions and experiences of other TCP connections established by the computing device at the time of identifying the stalled TCP connection. In particular, based on comparisons of stalled TCP connections to other TCP connections, the computing device may make new TCP connections access new data sources (e.g., different servers, etc.) and/or to new network interfaces (e.g., a different cellular network, a different radio access technology, etc.) that are potentially different than those used by the stalled TCP connections. In other words, the computing device may configure a new TCP connection to use the same network interface and/or access the same data source as a stalled TCP connection based on verifications of success (or failure) of other TCP connections with that network interface and/or data source. Such verifications of whether a stall is due to a problem with a network interface and/or data source of the stalled TCP connection may be performed by checking the progress metrics of more than one TCP connection (e.g., determining whether a majority of requests of TCP connections are stalling with the same interface and/or data source). For example, when a majority of active TCP connections configured to use the same network interface as the stalled TCP connection are determined to not be stalled based on predefined thresholds, the computing device may configure the new TCP connection to use the same network interface but a different data source than the stalled TCP connection for re-issuing the missing request. As another example, if a stalled TCP connection experiences poor performance but another TCP connection experiences acceptable performance when both utilize the same network interface, a new TCP connection that uses the same (or different) network interface and a different data source than used by the stalled TCP connection may be used by the computing device to re-issue a missing request of the stalled TCP connection.

As a general illustration, when a first TCP connection using a certain network interface is identified as providing poor performance (e.g., a long round-trip time), the computing device may check other TCP connections sharing the same network interface to determine whether they share the same poor performance. If the other TCP connections do not have poor performance on the same network interface, the first TCP connection may be considered stalled. To handle such events, the computing device may identify missing requests (e.g., missing byte range of HTTP requests, etc.) on the first TCP connection, optionally abandon the first TCP connection, and transmit the identified missing requests on a new TCP connection with that same network interface. Such a new TCP connection may or may not be configured to access a different data source (e.g., web server, etc.) than the stalled first TCP connection.

In various embodiments, the computing device may determine whether a TCP connection has stalled based on various monitored conditions of TCP connections or metrics, such as whether a certain request has been completed by a particular time frame, a time to setup a TCP connection, a time since the most recent successful reception/activity on the TCP connection, a throughput of the TCP connection for a period of time, a round-trip time of the TCP connection, and/or an estimate of the congestion window used by the TCP server for the TCP connection, etc. Monitored conditions or metrics may be evaluated against predefined thresholds, such as stored, static thresholds that may be compared to up-to-date status information (or progress metrics) of TCP connections. For example, in response to identifying the throughput of a certain TCP connection for a time period, the computing device may compare the identified throughput to a predefined minimum throughput threshold to determine whether the TCP connection may be considered stalled.

The term “lower layer(s)” may refer to the networking stack of the underlying operating system or other software stack that provides an interface for networking operations, such as an operating system's TCP implementation and/or various HTTP layer implementations. In some embodiments, stalls may be detected based on lower layer mechanisms and/or activities to recover from stalls. For example, lower layer mechanisms may retry connection setup attempts and/or retransmit based on timeouts or other congestion indicators. As another example, the computing device may determine a stall occurred when lower layer recovery mechanisms have failed (e.g., the threshold on the connection setup time may be configured to be sufficiently large to allow a certain number of retry attempts by the lower layer).

In some embodiments, the computing device may use the status of other TCP connections to determine whether a TCP connection has stalled. In other words, when monitoring the various TCP connections, the computing device may calculate statistics and generate dynamic (or adaptive) thresholds based on experiences of one or more of the various established TCP connections at a given time. For example, instead of or in addition to comparing the throughput of a TCP connection to a predefined, static threshold to determine whether the TCP connection is stalled, the computing device may compare the TCP connection's current throughput to an up-to-date throughput threshold calculated based on the throughput experiences of a plurality of TCP connections. As another example, the computing device may calculate an adaptive threshold for the time since last successful reception that depends on an outstanding bytes and a line rate. As another example, the computing device (e.g., via a specialized monitoring module) may estimate the best, current available line rate for a given networking interface that is used by a particular TCP connection to determine whether it is stalled at a given time. With such dynamic thresholds, tolerable performance in TCP connections may be variable over time based on a plurality of established TCP connections, allowing the determination of stalled conditions to change to reflect general networking conditions. For example, a TCP connection may not receive packets for a given time without being identified as stalled, as a current inactivity threshold may represent a longer-than-typical duration due to all the other TCP connections currently experiencing slow network activity.

In some embodiments, the computing device may perform testing to determine whether TCP connections are stalled, comparing the networking conditions (e.g., transfer success) of other established TCP connections to conditions of potentially stalled TCP connections. For example, when a first TCP connection is not receiving ACKs related to a request, the computing device may send the request on a second TCP connection to see whether the ACKs are received, which would indicate a problem with either the networking interface or the data source (e.g., remote content server) associated with the first TCP connection.

When a stall condition occurs on a TCP connection associated with a certain request due to packet errors, conventional TCP protocols may be capable of recovering independently, and thus the computing device may not need to classify the TCP connection as stalled, cancel the TCP connection, and/or reissue the request on a new TCP connection. In some embodiments, the computing device may utilize fixed (or predefined) thresholds (e.g., time since last reception, etc.) and/or adaptive thresholds to determine whether a TCP connection is stalled based on estimates of the reaction time of TCP protocols to recover from packet errors by itself In particular, the reaction time of TCP protocols may be estimated using the ratio of the number of outstanding bytes and the estimated rate of the network related to the TCP connection. For example, with a 4-second lower bound and a 30-second upper bound, the threshold may be computed with the following equation:

Stall_Detection_Threshold=min(30, max(4, outstanding bytes/rate estimate)).

In some cases, when a networking option (i.e., a combination of network interface and data source) as a whole has some problem (e.g., overload), a majority of the TCP connections using that networking option may experience a stall. So, reissuing missing requests using the same networking option may not cause a successful reception of the missing requests. In some embodiments, the computing device may be configured to evaluate whether a whole networking option (e.g., data source and network interface) is likely to be useful for re-issuing a missing request by evaluating progress metrics (e.g., the success) of various other TCP connections already configured to utilize that whole networking option. For example, after selecting a network interface and/or data source for re-issuing a missing request of a stalled TCP connection on a new TCP connection, the computing device may verify that the selected networking option is successful for the majority of other TCP connections currently using that network interface and data source (i.e., whether the other TCP connections are stalling). If the whole networking option is not verified as currently successful for other TCP connections, the computing device may not reissue the missing request, or alternatively, issue the missing request using a different networking option (e.g., a different combination of network interface and data source).

In some embodiments, new TCP connections may be configured to utilize the same data source and network interface as a stalled TCP connection in response to the computing device determining other TCP connections using these configurations are not stalling. In other words, when a certain TCP connection stalls due to conditions exclusive to it (e.g., faulty cell link connection to only the TCP connection, etc.), the computing device may simply create a new TCP connection that uses the same network interface and data source to complete missing requests. This may also be useful when a TCP connection has an error or throttling mechanism that may simply require a new TCP connection configured similarly.

In some embodiments, when a plurality of TCP connections are stalled on a common data transfer, the computing device may prioritize requests for the stalled TCP connections. For example, the computing device may select the highest priority request of a first stalled TCP connection to be transmitted on a new TCP connection and then transmit on another new TCP connection a second request of a second stalled TCP connection. Priority (or order) of requests may be based on various factors, such as time when a request was originally issued by an application (e.g., most urgent or oldest requests are reissued first), a deadline associated with the request, and/or the nature of the application or request (e.g., live video streaming or broadcast data may have higher priority than non-live video streaming or a file download). As an illustration, if a video object is requested in portions over several TCP connections, the video portion that needs to be played back first via a video application and requested on a first stalled TCP connection may have priority over a newer portion requested on a second stalled TCP connection. Such requests may be re-issued in sequence (i.e., in a non-interlacing manner). In some embodiments, the computing device may select requests based on a reissue rate limit that limits the number of requests that may be reissued per unit time.

In some embodiments, the computing device may maintain a stalled TCP connection in addition to a related new TCP connection in case the stalled TCP connection returns to service. For example, instead of cancelling a stalled TCP connection in response to re-issuing its missing requests on a new TCP connection, the computing device may allow the stalled TCP connection to continue to operate until the missing request is completed on either the new TCP connection or the stalled TCP connection. The first successful TCP connection may be kept and the other TCP connection may be cancelled.

In various embodiments, re-issued missing requests may include entire or full requests (e.g., the last request for data that was not fully received on the stalled TCP connection) or partial requests for only the data identified in the missing request that was not received (i.e., missing from a previous request), such as a missing byte range of a request. For example, the computing device may identify missing portions of an entire data request to re-issue on a new TCP connection. In some embodiments, the identified missing portions of the data may be further split into smaller portions and re-issued on more than one new TCP connection. In particular, computing devices may be configured to process, monitor for, and otherwise handle “chunks” of data related to requests sent via TCP connections. Such chunks may be associated with chunk identifiers (or IDs) that are unique to each chunk and that are assigned in the order in which the chunks were originally issued. For example, when a first chunk (e.g., “Chunk A”) is issued before a second chunk (e.g., “Chunk B”), the chunk identifier of the first chunk may be a number that is less than the chunk identifier of the second chunk (e.g., chunk ID of Chunk A is less than chunk ID of Chunk B). In various embodiments, when a request for a chunk having a first chunk identifier is canceled (or missing) and retried via a new request on a new TCP connection, the chunk of the new request on the new TCP connection may utilize the same first chunk identifier. The embodiment techniques may work well with request-driven protocols, such as HTTP requests, where the computing device can request specific objects, or even specific portions of objects (e.g., specific byte ranges of files) to avoid redundant data transfers (e.g., request only the byte range that has not already been received before the stall occurred).

In some embodiments, reordering buffer occupancy may be used as an input. Bytes arriving on multiple TCP connections need to be reordered in a reordering buffer for in-order delivery to the application. If one TCP connection is slow or stalled while other connections are fast, the slow connection may throttle in-order delivery of bytes to the application; out-of-order bytes arriving on the other fast connections will cause the reordering buffer occupancy to grow. Thus, an additional input to deciding whether to retry a request may be based on the reordering buffer occupancy exceeding a threshold. In some embodiments, it may be based on an estimate of how high the reordering buffer occupancy will grow before the request on the slow TCP connection is completed. The estimated occupancy may be compared with a fixed threshold that may depend on the buffer size limit. Alternately, the estimated occupancy may be compared with the corresponding estimate when the request is retried on a different connection or using a different networking interface; the option which gives the lowest estimate may be selected. These estimates of the buffer occupancy may be calculated based on the current reordering buffer occupancy, round-trip time, average rate of the slow TCP connection, the rates of the other TCP connections and the expected rate of the retried request on the new TCP connection.

The following is an illustration of using the reordering buffer occupancy as an input. B may be the current occupancy of the reordering buffer, RTT is an estimate of the round-trip time, Rslow is the rate for the slow TCP connection, Nslow is the number of requested bytes that are still outstanding on the slow connection, Rtotal is the total rate of all the TCP connections, Rexp is the expected rate of the retried request on the new TCP connection. Without retry, estimated occupancy of the buffer before slow request completes=B+Nslow*(Rtotal/Rslow−1). With retry, estimated occupancy of the buffer before slow request completes=B+(RTT+Nslow/Rexp)*(Rtotal−Rexp). Such calculations may assume that the rate of increase of the reordering buffer is the difference between the total incoming data rate on all TCP connections and the total incoming rate of the slow connection. The incoming rate of the slow connection may be the draining rate of the reordering buffer if the slow connection corresponds to the head-of-line blocking request.

In some embodiments, delivery rate to application (or egress rate) may be used by the computing device as an input for determining whether to reissue requests. Delivery rate to application (or egress rate) may refer to the rate at which in-order bytes are delivered to an application via a TCP connection. If one TCP connection is slow or stalled while other TCP connections are fast, the slow TCP connection may throttle in-order delivery of bytes to the application, even if the overall ingress rate of bytes from the network is high. Thus, an additional input to deciding whether to retry a request (i.e., whether a TCP connection is stalled) may be based on whether the delivery rate to application (or egress rate) is less than the ingress rate by a specified threshold for a specified duration. For example, if a TCP connection is stalled, but the delivery rate to application (or egress rate) is comparable to the ingress rate, the stalled connection may be considered not yet the head-of-line and not blocking the delivery of bytes. Accordingly, there may be no need to retry the request on that TCP connection yet. However, if the delivery rate to application (or egress rate) is much lower than the ingress rate, this may increase the confidence in the decision to retry a request in addition to looking at the progress metrics of each TCP connection. Optionally, the computing device may identify and exclude the case where the delivery rate to application (or egress rate) is limited because of the application not reading bytes fast enough.

The embodiment techniques may intelligently improve streaming media services and downloading experiences by identifying stalled TCP connections and re-issuing missing requests on new TCP connections configured to avoid the conditions that may contribute to stalling. Such embodiment techniques are beneficial by improving the functioning of computing devices by providing proactive recovery mechanisms that ensure applications (e.g., media streaming applications, etc.) do not experience long outages during data transfers. For example, the time between successive read events may be reduced, thereby reducing the time during which an application executing on the computing device is latent, being ready to read bytes without having any in-order bytes available for reading. With such improvements and shorter latent periods, computing devices utilizing the embodiment techniques may be capable of executing applications (e.g., video streaming applications) that have fewer interruptions in video playbacks.

Conventional systems exist that address stalled playbacks of streaming content, such by evaluating received data within a playback buffer. The embodiment techniques do not address playback issues, but instead provide techniques for new TCP connections, configured based on a plurality of TCP connection experiences, to overcome stalled TCP connections. Other conventional techniques may evaluate the speed of various connections, as well as whether certain connections are urgent, disclosing that urgent requests on slow connections may be replaced on fast connections. However, such conventional techniques do not evaluate other TCP connections of a computing device to determine whether to and/or how to reissue requests on new TCP connections. In particular, the embodiment techniques are different at least in that network interfaces and/or data sources of various TCP connections may be compared in order to determine how to configure a new TCP connection for re-issuing requests of a cancelled, stalled TCP connection. The embodiment techniques may also monitor various TCP connections to determine how to successfully configure new TCP connections to complete missing requests of stalled TCP connections.

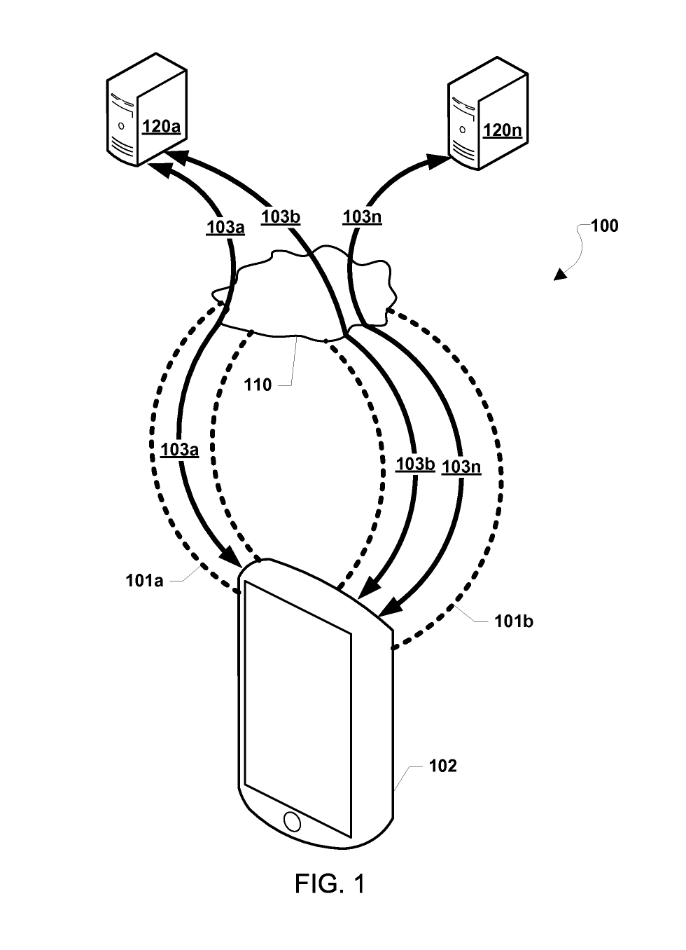

FIG. 1 illustrates an exemplary communication system 100 including a computing device 102 (e.g., a smartphone mobile device, a laptop computer, a desktop computer, etc.) and a plurality of data sources 120a, 120n (e.g., data servers, web servers, remote database devices, etc.). The computing device 102 and the data sources 120a, 120n may be configured to communicate over the Internet 110, such as via wired or wireless connections. For example, the data sources 120a, 120n may be connected to the Internet 110 via wired connections. As another example, the computing device 102 may be configured to exchange wireless communications with a base station (not shown) associated with a cellular network providing access to the Internet 110 and/or may be configured with a wired connection (e.g., Ethernet connection to a modem and/or router device) providing access to the Internet 110. In some embodiments, the data sources 120a, 120n may be associated with different services and/or data, such as different web sites or databases, or alternatively, may be configured to provide the same information, such as redundant web servers providing similar access to the same web page data.

The computing device 102 may be configured to utilize a plurality of network interfaces 101a, 101b to communicate with the data sources 120a-120n via Internet protocols. In particular, the computing device 102 may be configured to transmit data requests (e.g., HTTP requests) to any or all of the data sources 120a-120n via Transmission Control Protocol (TCP) connections 103a-103n using the plurality of network interfaces 101a, 101b. For example, the computing device 102 may establish a first TCP connection 103a with the first data source 120a via a first network interface 101a, and may establish a second TCP connection 103b with the first data source 120a via the second network interface 101b. As another example, the computing device 102 may establish a third TCP connection 103n with the second data source 120n via the second network interface 101b. In various embodiments, the various network interfaces 101a, 101b supported by the computing device 102 may be associated with different communication technologies, such as a Long Term Evolution (LTE) cellular network interface and a Global System for Mobile Communication (GSM) cellular network interface, and/or different or the same communication equipment, such as different or the same transceivers and/or antenna for receiving and transmitting signals via electromagnetic radiation. In various embodiments, the network interfaces 101a, 101b may be any combination of software, sockets, ports, controllers, and/or hardware supported by the computing device 102.

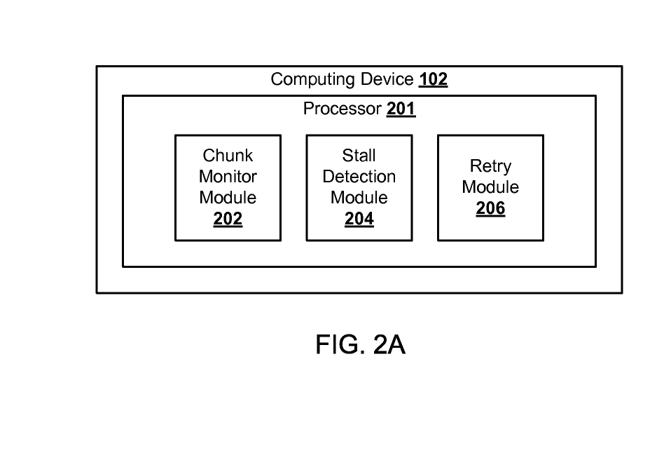

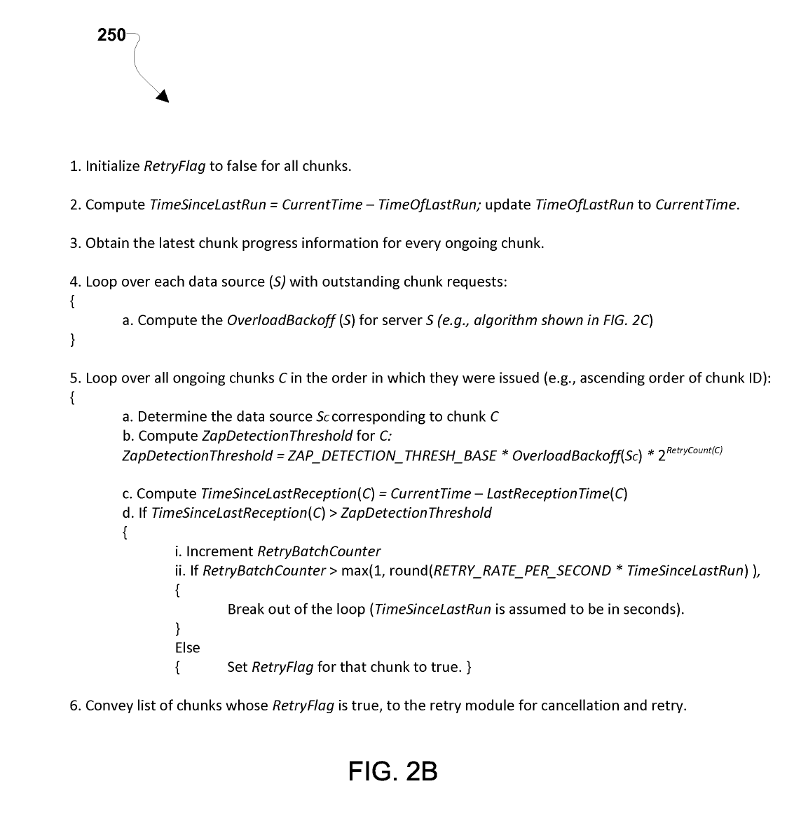

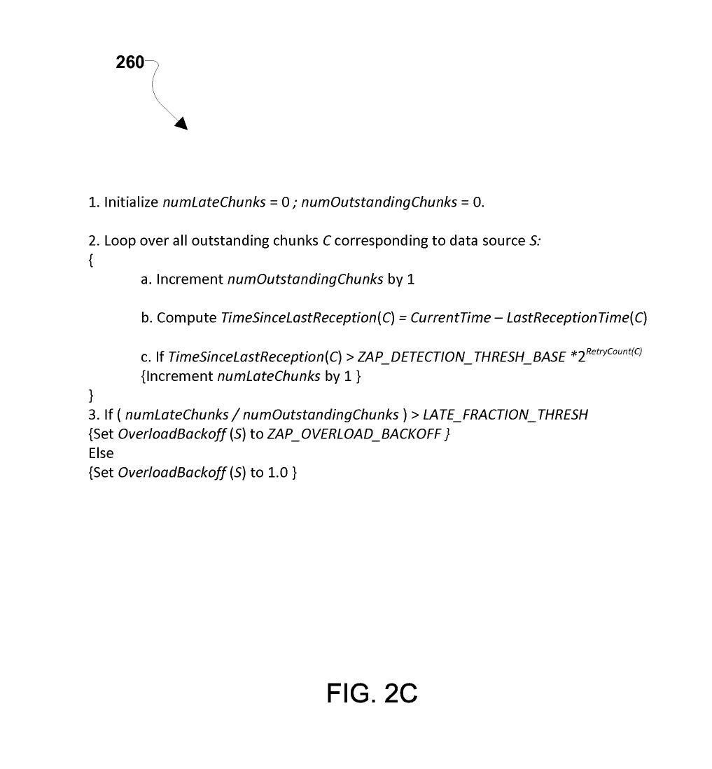

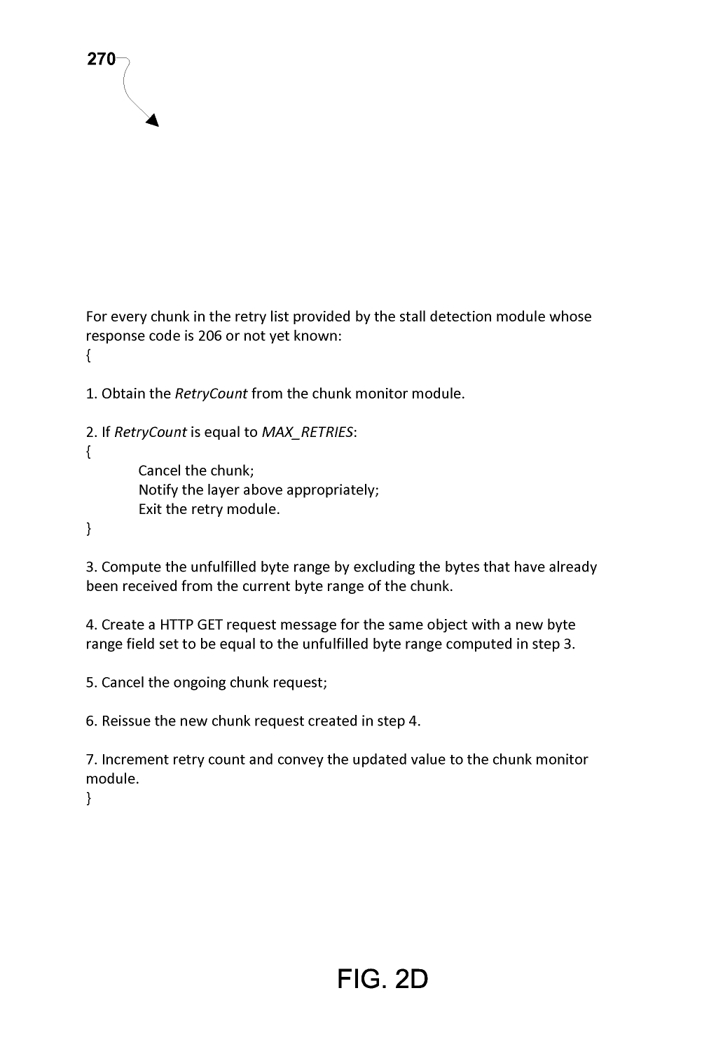

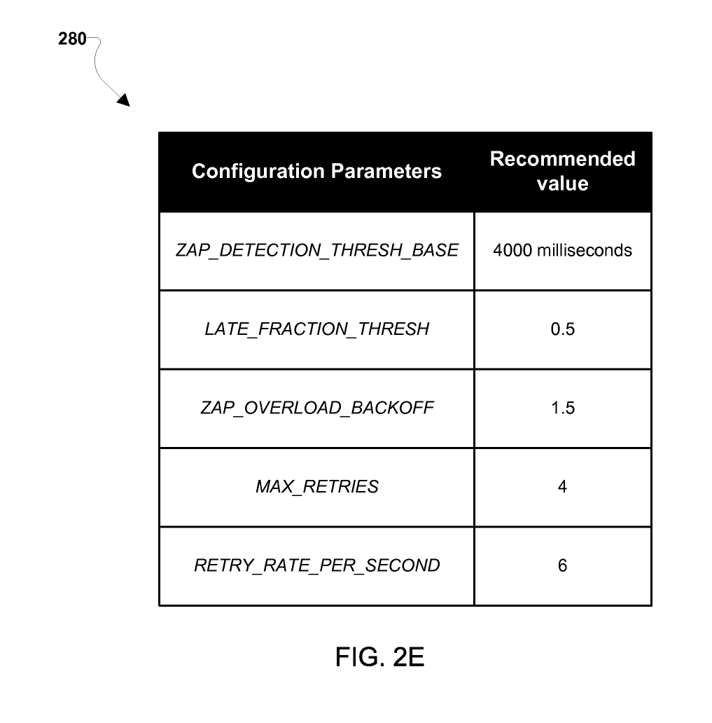

FIG. 2A illustrates embodiment modules 202-206 configured to be executed by a processor 201 of an exemplary computing device 102. In general, the computing device 102 may be configured to determine whether a request on a TCP connection is stalling and thereby blocking the delivery of bytes to various layers, such as application layers. In such scenarios, the computing device 102 via its recovery functionalities may be configured to cancel the stalled request on an original TCP connection and reissue the request on a different, new TCP connection. In particular, the computing device 102 may support a chunk monitor module 202, a stall detection module 204, and a retry module 206. Such modules 202-206 may be software, applications, routines, logic, instructions, and other information that may be executed and/or otherwise utilized by processor 201 of the computing device 102.

In some embodiments, the modules 202-206 executed by the computing device may be configured to utilize various equations and parameters for making calculations and/or determinations as described below. Exemplary values for parameters in such determinations/calculations are illustrated in FIG. 2E. Referring to FIG. 2E, the ZAP_DETECTION_THRESH_BASE parameter may refer to the base threshold on the time since last successful reception beyond which a TCP connection may be declared to be stalling. This base threshold may be further modified based on other inputs, such as the progress of other TCP connections, the expected TCP reaction time, etc. The LATE_FRACTION_THRESH parameter may be a threshold on the fraction of TCP connections that are declared as stalled beyond which an overload condition may be inferred. Such an overload condition may correspond to an overload at the data source. The ZAP_OVERLOAD_BACKOFF parameter may be used to scale up the threshold on the time since last reception in case an overload condition is detected. The MAX_RETRIES parameter may refer to the maximum limit on the number of times a chunk may be reissued before abandoning the request and informing the layer above appropriately. The RETRY_RATE_PER_SECOND parameter may specify the number of retries allowed per unit time in order to avoid excessively frequent reissuing of requests. In some embodiments, the exemplary values may also include ranges of valid values for each of the configuration parameters to provide some basic checks to avoid misconfiguration. For example, data may be stored that indicates an inclusive range of [0, 65535] milliseconds is a valid range for the ZAP_DETECTION_THRESH_BASE parameter, data may be stored that indicates an inclusive range of [0, 1] is a valid range for the LATE_FRACTION_THRESH parameter, data may be stored that indicates an inclusive range of [1, 100] is a valid range for the ZAP_OVERLOAD_BACKOFF parameter, data may be stored that indicates an inclusive range of [0, 255] is a valid range for the MAX_RETRIES parameter, and/or data may be stored that indicates an inclusive range of [0, 255] is a valid range for the RETRY_RATE_PER_SECOND parameter.

In various embodiments, the chunk monitor module 202 may be a module configured to monitor the progress of downloads associated with requests (e.g., monitor the status of downloading chunks of data). Further, the chunk monitor module 202 may maintain various information about every ongoing request (or chunk) in a data structure (e.g., a chunk progress information, data table, etc.). For example, the chunk monitor module 202 may store timestamp information (e.g., a “LastReceptionTime” data field) indicating the last occurrence of a read operation from a TCP connection associated with a particular chunk of a request, and data (e.g., a “RetryCount” data field) that is incremented by the retry module for every retry of a stalled request. As another example, the computing device may initialize data that indicates when a request for a chunk is issued for the first time (e.g., issued on an original TCP connection), such as by initializing chunk progress information by setting a LastReceptionTime data field to the timestamp for the time when the request for the chunk was issued and setting a RetryCount data field to a zero value.

In various embodiments, the stall detection module 204 may be a module configured to determine based on information provided by the chunk monitor module 202 which requests for chunks need to be canceled and reissued, such as via new TCP connections. The stall detection module 204 may be configured to indicate the outcome of such determinations to the retry module 206.

In some embodiments, the stall detection module 204 may execute the following algorithm whenever triggered. The stall detection module 204 may initialize a RetryFlag to false for all chunks, compute TimeSinceLastRun=CurrentTime−TimeOfLastRun, and update TimeOfLastRun to CurrentTime. The stall detection module 204 may obtain the latest chunk progress information for every ongoing request for chunks. Using a data source-wide view of chunks to check whether a server is overloaded and thus selecting a backoff factor to apply to detection thresholds, for each data source S with outstanding chunk request, the stall detection module 204 may compute an OverloadBackoff (S), wherein S is a server with an outstanding chunk request. The stall detection module 204 may check each chunk request to determine whether to reissue the request or not by looping over all ongoing chunks (C) in an order (e.g., the order in which the chunks were issued, in ascending order of chunk ID, etc.), determining the data source (SC) corresponding to each chunk, and compute a ZapDetectionThreshold for C, wherein:

ZapDetectionThreshold=ZAP_DETECTION_THRESH_BASE*OverloadBackoff(SC)*2^{RetryCount(C)}.

The stall detection module 204 may also compute TimeSinceLastReception(C)=CurrentTime−LastReceptionTime(C), and determine whether TimeSinceLastReception(C) is greater than ZapDetectionThreshold. If TimeSinceLastReception(C) is greater than ZapDetectionThreshold, the stall detection module 204 may increment RetryBatchCounter and, if RetryBatchCounter is greater than a certain value (e.g., the maximum of a ‘1’ value and the result of a rounded value of (RETRY_RATE_PER_SECOND*TimeSinceLastRun)), the stall detection module 204 may break out of the loop. However, if RetryBatchCounter is not greater than the certain value, the stall detection module 204 may set the RetryFlag for that chunk request to ‘true’. The stall detection module 204 may then convey a list of chunk requests whose RetryFlag is set to ‘true’ to the retry module 206 for cancellation and retry (or reissue). In this example, TimeSinceLastRun may be assumed to be a number of seconds. FIG. 2B illustrates pseudocode 250 of such an exemplary algorithm.

In some embodiments, the stall detection module 204 may be configured to compute a backoff related to the overload of servers. For example, if requests on TCP connections are stalling because of a server overload, then retrying requests repeatedly could make the situation even worse. Such an overload backoff calculation may address this problem by adjusting the ZapDetectionThreshold to a larger value if a large fraction of the chunk requests are stalling for a particular data source (e.g., data source). In some embodiments, the stall detection module 204 may execute the following algorithm to adjust the ZapDetectionThreshold. The stall detection module 204 may initialize a numLateChunks variable to a zero value and a numOutstandingChunks variable to a zero value. The stall detection module 204 may perform the following loop for all outstanding chunk requests (C) corresponding to data source S: increment a numOutstandingChunks variable by 1, compute TimeSinceLastReception(C)=CurrentTime−LastReceptionTime(C), determine whether TimeSinceLastReception(C) is greater than ZAP_DETECTION_THRESH_BASE*2^{RetryCount(C)}, increment numLateChunks by 1 when it is determined that TimeSinceLastReception(C) is greater than ZAP_DETECTION_THRESH_BASE*2^{RetryCount(C)}, determine whether (numLateChunks/numOutstandingChunks) is greater than a LATE_FRACTION_THRESH threshold variable, set OverloadBackoff (S) to ZAP_OVERLOAD_BACKOFF in response to determining (numLateChunks/numOutstandingChunks) is greater than the LATE_FRACTION_THRESH threshold variable, and set OverloadBackoff (S) to 1.0 in response to determining (numLateChunks/numOutstandingChunks) is not greater than the LATE_FRACTION_THRESH threshold variable. FIG. 2C illustrates pseudocode 260 of such an exemplary algorithm.

In various embodiments, the retry module 206 may enforce the decision of the stall detection module 204. For example, the retry module 206 may cancel stalled requests on TCP connections and issue new requests on new TCP connections. While issuing new chunk requests, the retry module 206 may take into account any bytes that may have already been received for previous chunk requests before stalled requests are cancelled. Such new chunk requests may only request the remainder of the byte range that has not yet been received via previous successful requests.

In some embodiments, if the response to a chunk request contains an error code with some content body, then retry mechanisms may not be employed. This is because, a reissue of the request is likely to generate another error response with the full content body (i.e., the error response body may not comply with the byte range requested). Therefore, retry module 206 operations as described below may only be applied to chunk requests for which a stall has been detected and whose headers contain a ‘206’ HTTP response code or whose response code is not yet known (e.g., requests where no header is yet received). In other words, the retry module 206 may ignore the progress of chunk requests that have a code different than a ‘206’ HTTP response code or an unknown code.

In some embodiments, the retry module 206 may execute the following algorithm. In response to the indication from the stall detection module, the retry module 206 may, for every chunk request in the retry list provided by the stall detection module 204 whose response code is ‘206’ or not yet known, obtain the RetryCount from the chunk monitor module 202, determine whether RetryCount is equal to MAX_RETRIES. In response to determining the RetryCount is equal to MAX_RETRIES, the retry module 206 may cancel the chunk, notify a layer above appropriately (e.g., provide an error response to the application that initiates the network transactions), and exit the retry module. In some embodiments, if no data has been delivered for this chunk request to the layer above, then the notification to the layer above may be in the form of a HTTP server error message. Additionally or alternatively, the layer above may be notified through the closing of the network connection associated with the chunk request. The layer above may propagate the notification to other modules and eventually to the application that initiated the network transaction. Then, the computing device may exit the retry module.

However, in response to determining the RetryCount is not equal to MAX_RETRIES, the retry module 206 may compute the unfulfilled byte range by excluding the bytes that have already been received from the current byte range of the chunk request, create a HTTP GET request message for the same object with a new byte range field set to be equal to the unfulfilled byte range, cancel the ongoing chunk request, reissue the new chunk request created, increment a retry count, and convey the updated value to the chunk monitor module 202. FIG. 2D illustrates pseudocode 270 of such an exemplary algorithm.

In various embodiments, the stall detection module 204 may be triggered every 500 milliseconds when outstanding chunk requests are present. If necessary, the stall detection module 204 may trigger the retry module 206 for retrying chunk requests. Further, the chunk monitor module 202 may update the progress of a chunk request whenever bytes are read successfully for the chunk request. In addition, the chunk monitor module 202 may update the RetryCount field based on an indication from the retry module 206.

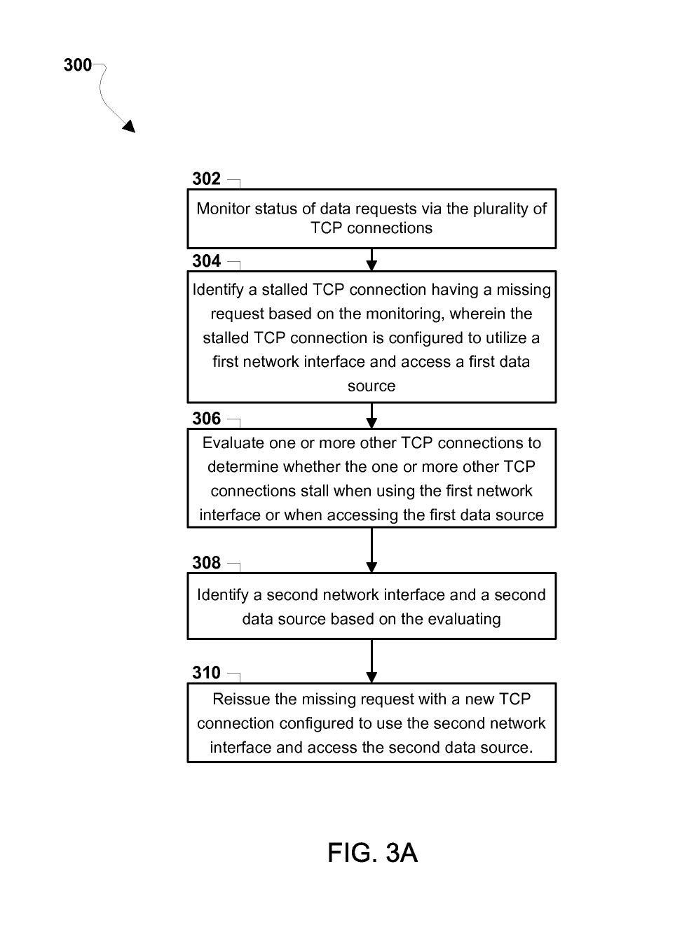

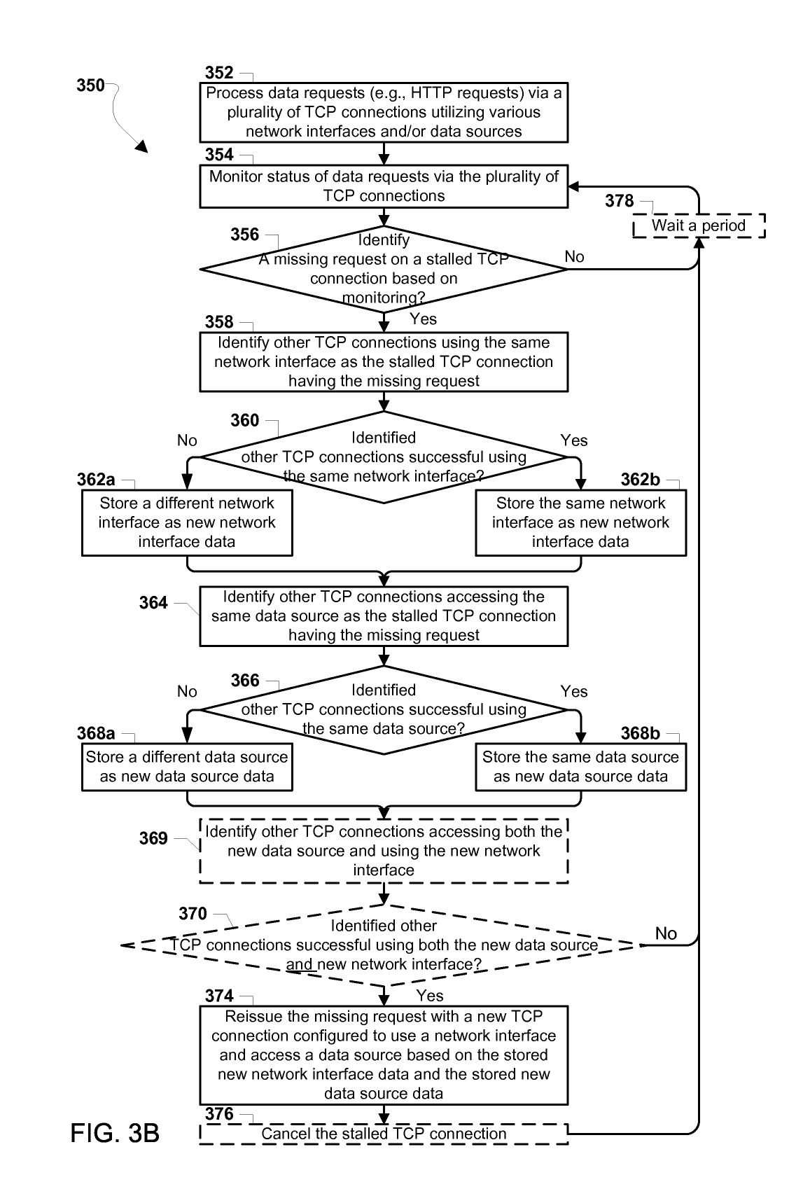

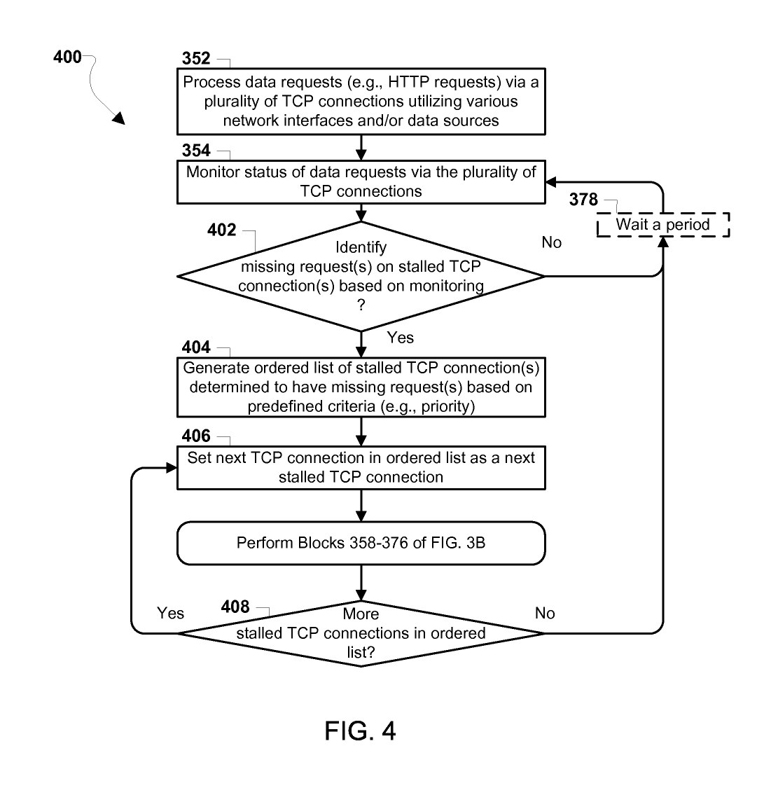

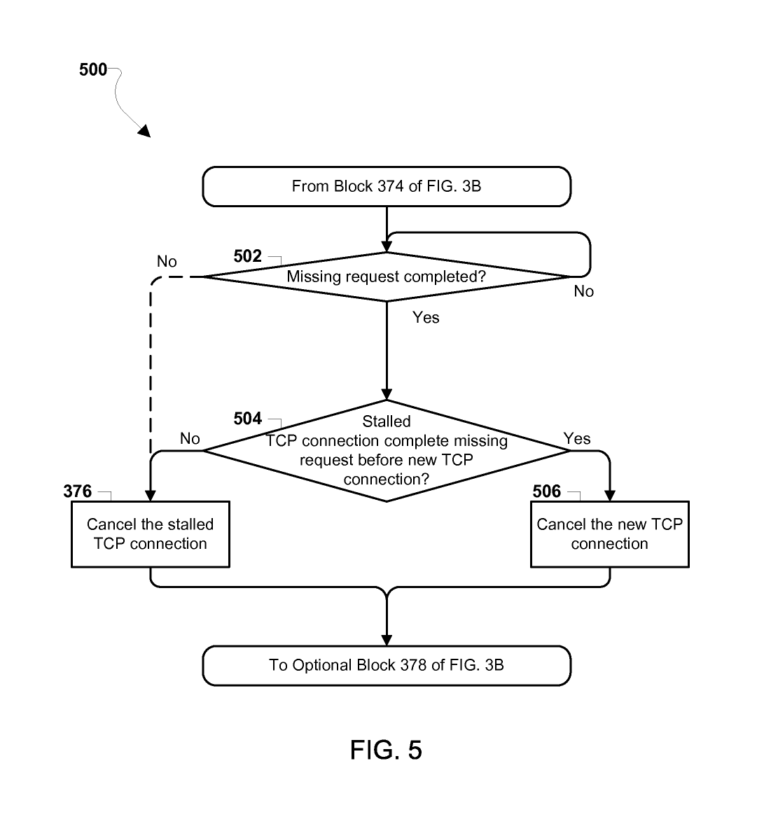

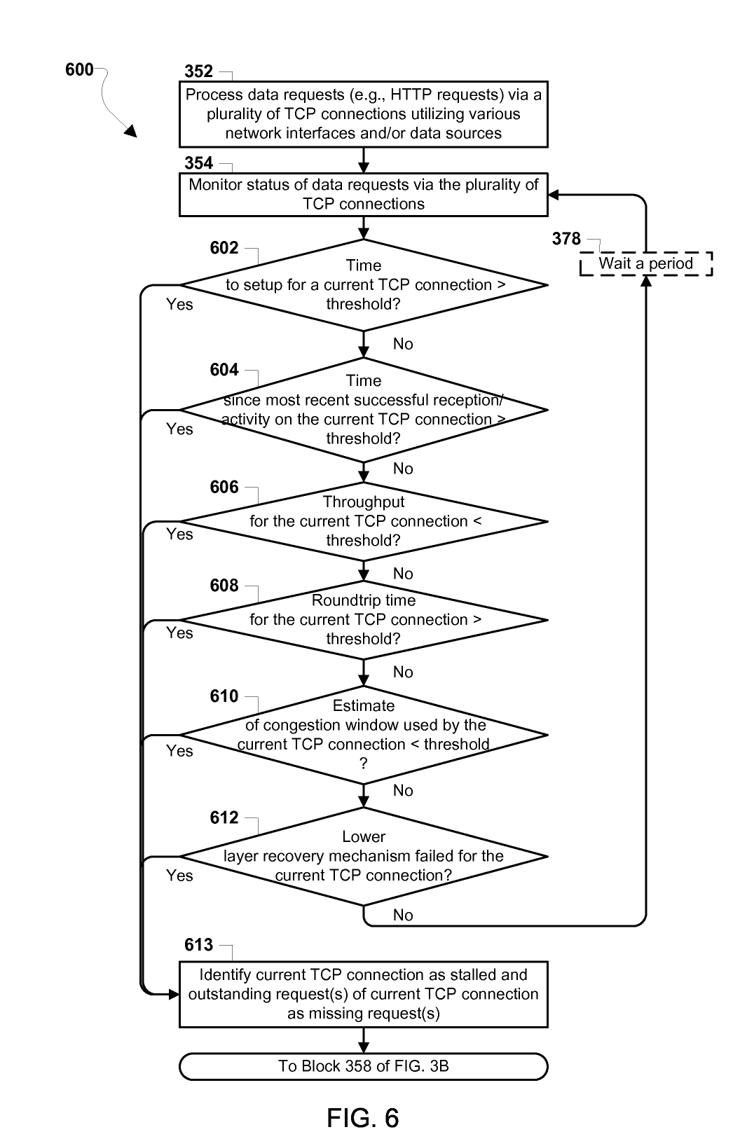

FIG. 3A illustrates a simplified embodiment method 300 for a computing device to reissue requests (e.g., HTTP requests) of stalled TCP connections on new TCP connections configured based on data related to other TCP connections utilized by the computing device. A more detailed embodiment method 350 is described in FIG. 3B. The operations of method 300 may be performed by the processor of the computing device, and further may be handled via various modules, logic, software, instructions, and operations executed by the processor (e.g., the modules 202-206 described with reference to FIGS. 2A-2E).

In block 302, the processor of the computing device may monitor the status of data requests of a plurality of TCP connections. In block 304, the processor of the computing device may identify a stalled TCP connection having a missing request based on the monitoring, wherein the stalled TCP connection is configured to utilize a first network interface and access a first data source. In block 306, the processor of the computing device may evaluate one or more other TCP connections to determine whether the one or more other TCP connections stall when using the first network interface or when accessing the first data source. In block 308, the processor of the computing device may identify a second network interface and a second data source based on the evaluating. In block 310, the processor of the computing device may reissue the missing request with a new TCP connection configured to use the second network interface and access the second data source. In various embodiments, based on the evaluations, the second network interface may be the same as the first network interface and/or the second data source may be the same as the first data source.

FIG. 3B illustrates an embodiment method 350 for a computing device to reissue requests (e.g., HTTP requests) of stalled TCP connections on new TCP connections configured based on data related to other TCP connections utilized by the computing device. The method 350 is similar to the method 300, except that the method 350 includes additional detailed operations. The operations of method 350 may be performed by the processor of the computing device, and further may be handled via various modules, logic, software, instructions, and operations executed by the processor (e.g., the modules 202-206 described with reference to FIGS. 2A-2E).

In block 352, the processor of the computing device may process data requests (e.g., HTTP requests, chunk requests, etc.) via a plurality of TCP connections utilizing various network interfaces (e.g., communication protocols, communication hardware, etc.) and/or data sources (e.g., remote data servers, etc.). For example, the computing device may establish and utilize a plurality of TCP connections for requesting and receiving streaming media data segments from a remote web server for use with a video application. In some embodiments, the plurality of TCP connections may be associated with the same or different applications. In block 354, the processor of the computing device may monitor the status of data requests (e.g., chunk requests) via the plurality of TCP connections. For example, the computing device may calculate statistics for the individual TCP connections of the plurality of TCP connections and/or for some or all of the plurality of TCP connections. The monitoring operations may include evaluating various metrics and/or conditions of the TCP connections, such as whether a certain request has been completed by a particular time frame, a time to setup a TCP connection, a time since the most recent successful reception/activity on the TCP connection, a throughput of the TCP connection for a period of time, a round-trip time of the TCP connection, and/or an estimate of the congestion window used by the TCP server for the TCP connection, etc.

In determination block 356, the processor of the computing device may determine whether it identifies a missing request on a stalled TCP connection based on the monitoring of the operations of block 354. For example, for each of the plurality of TCP connections, the computing device may evaluate various conditions and/or metrics, such as throughput, time since last activity, etc., to detect whether each TCP connection is stalled or not. Further, when TCP connections are identified as stalled, the computing device may identify any requests (or portions of requests) that have been issued on the stalled TCP connections that have not been completed. For example the computing device may identify an HTTP request or a byte range of the HTTP request that have not been completed or received via a certain stalled TCP connection. In some embodiments, the determinations of determination block 356 may include comparing data (e.g., monitored data, statistics, status information, etc.) about the plurality of TCP connections to predefined and/or dynamic thresholds, such as described herein.

In response to determining whether the computing device has not identified a missing request on a stalled TCP connection based on the monitoring (i.e., determination block 356=“No”), the processor of the computing device may wait a period in optional block 378, such as a predefined number of seconds or milliseconds, and then may continue with the monitoring operations in block 354. In response to determining that the computing device identified a missing request on a stalled TCP connection based on the monitoring (i.e., determination block 356=“Yes”), the computing device may evaluate the other TCP connections to determine whether the stalled TCP connection's network interface and/or data source may be used with a new TCP connection for reissuing the missing request. To do so, the processor of the computing device may identify other TCP connections using the same network interface as the stalled TCP connection having the missing request in block 358. For example, the computing device may perform a look-up on a stored data table indicating the current configurations of all TCP connections in the plurality of TCP connections (e.g., all TCP connections associated with the same application as the stalled TCP connection, etc.) to identify the other TCP connections currently using the same network interface.

In determination block 360, the processor of the computing device may determine whether the identified other TCP connections are successful using the same network interface. In other words, based on the monitoring of block 354, the computing device may determine whether the other identified TCP connections are stalled when using the same network interface as the stalled TCP connection. In some embodiments, the computing device may utilize a threshold number of other TCP connections that are successful or unsuccessful using the same network interface at a given time to determine whether to continue using the same network interface or select a new network interface for the new TCP connection. For example, if a predefined percentage of all TCP connections using the network interface are struggling to receive packets, then a new network interface may be selected. In some embodiments, the determinations may be made based on the monitored information of block 354 and/or based on additional statistics and/or testing or observations of the other TCP connections, such as success rates of test data requests sent over the same network interface via the other TCP connections.

In response to determining the identified other TCP connections are not successful using the same network interface (i.e., determination block 360=“No”), the processor of the computing device may store a different network interface as a new network interface data in block 362a. Such a new network interface data may be stored information that may indicate configuration parameters for a new TCP connection that may be created to re-issue the missing request of the stalled TCP connection. In response to determining the identified other TCP connections are successful using the same network interface (i.e., determination block 360=“Yes”), the processor of the computing device may store the same network interface as the new network interface data in block 362b.

In response to performing the operations in block 362a or block 362b, the processor of the computing device may identify other TCP connections that are accessing the same data source (e.g., server) as the stalled TCP connection having the missing request in block 364. Similar to the operations in block 358, the computing device may make such identifications based on evaluating stored configuration information of currently active TCP connections to identify those accessing the same data source as the stalled TCP connection. However, it should be appreciated that the one or more TCP connections identified with the operations in block 364 may or may not be the same as identified with the operations in block 358. In determination block 366, the processor of the computing device may determine whether the identified other TCP connections are successful using the same data source.

In other words, based on the monitoring of block 354, the computing device may determine whether the other identified TCP connections are stalled when using the same data source as the stalled TCP connection. In some embodiments, the computing device may utilize a threshold number of other TCP connections that are successful or unsuccessful using the same data source at a given time to determine whether to continue using the same data source or select a new data source for the new TCP connection. For example, if a predefined percentage of all TCP connections using the same data source are struggling to receive packets, then a new data source may be selected. In some embodiments, the determinations may be made based on the monitored information of block 354 and/or based on additional statistics and/or testing or observations of the other TCP connections, such as success rates of test data requests sent to the same data source via the other TCP connections.

In response to determining the identified other TCP connections are not successful using the same data source (i.e., determination block 366=“No”), the processor of the computing device may store a different data source as a new data source data in block 368a. Similar to the new network interface data as described above, such a new data source data may be stored information that may indicate configuration parameters for a new TCP connection that may be created to re-issue the missing request of the stalled TCP connection. In response to determining the identified other TCP connections are successful using the same data source (i.e., determination block 366=“Yes”), the processor of the computing device may store the same data source as the new data source data in block 368b.

In response to performing the operations in block 368a or block 368b, the processor of the computing device may perform optional operations to verify that TCP connections configured to use both the new network interface and new data source are not already known to be stalled, and thereby indicating that the new network interface and new data source may not be successful for a new TCP connection and a reissue of the missing request. In other words, the computing device may verify whether the new networking option as a whole (e.g., the new network interface and the new data source) may be successful for reissues. In optional block 369, the processor of the computing device may identify other TCP connections accessing both the new data source and using the new network interface. As indicated above, the one or more other TCP connections accessing both the new data source and using the new network interface may or may not be the same as those identified with the operations in block 358 or block 364. In optional determination block 370, the processor of the computing device may determine whether the identified other TCP connections using both the new data source and new network interface are successful. For example, this verification may be performed by checking the progress metrics of the identified other TCP connections using the new data source and new network interface to determine whether a majority (or some other predefined amount) of the identified other TCP connections using the new data source and new network interface are stalling. The operations in optional determination block 370 may be useful for avoiding re-issuing with a new TCP connection with a network interface and data source that are the same as those used by TCP connections already experiencing stalls (e.g., the stalled TCP connection, etc.). For example, when other TCP connections would stall using the identified new network interface and new data source, no new TCP connection should be made, as it may likely stall as well. In response to determining the identified other TCP connections using both the new data source and new network interface are not successful (i.e., optional determination block 370=“No”), the computing device may perform the waiting operations in optional block 378.

In response to determining the identified other TCP connections using the new data source and new network interface are successful (i.e., optional determination block 370=“Yes”), the processor of the computing device may reissue the stalled request with a new TCP connection configured to use a network interface and access a data source based on the stored working network interface data and the stored working data source data in block 374. In optional block 376, the processor of the computing device may cancel the current TCP connection, and the processor of the computing device may wait a period in optional block 378, such as a predefined number of second, milliseconds, etc. For example, the computing device may backoff the retry frequency of a stalled request based on the number of new TCP connections used for the same request to avoid excessive retries of the stalled request when there are poor network conditions due to congestion, etc. In some embodiments, if a majority of TCP connections for the same data source (e.g., same data source) are stalling because of a server overload, the computing device may be configured to detect this situation and reissue (or retry) stalled requests less often to avoid making the overloading even worse. The computing device may continue monitoring the status of various data requests on the plurality of TCP connections in block 354. In some embodiments, the computing device may handle new data requests in block 352 as described.

Although not shown in FIG. 3B, it should be appreciated that the operations in blocks 358-376 may be performed by the computing device as an operational loop for each of the TCP connections that are identified as stalled and associated with missing requests such that each missing request may be reissued on a new TCP connection.

FIG. 4 illustrates an embodiment method 400 for a computing device to reissue requests (e.g., HTTP requests) of stalled TCP connections on new TCP connections configured based on data related to other TCP connections utilized by the computing device and in an ordered manner. The operations of method 400 are similar to the operations of the embodiment method 350 described with reference to FIG. 3B, except that the method 400 may include operations for determining an order to the requests that are to be re-issued, such as when the requests are related to set of data that may be rendered in a particular sequence. Similar to as described above, the operations of the method 400 may be performed by the processor of the computing device, and further may be handled via various modules, logic, software, instructions, and operations executed by the processor (e.g., the modules 202-206 described with reference to FIGS. 2A-2E).

The operations of blocks 352-354, 358-378 may include operations as described above with reference to FIG. 3B. In response to monitoring the plurality of TCP connections in block 354, the processor of the computing device may determine whether there are identified missing request(s) on stalled TCP connection(s) based on the monitoring. In other words, the computing device may determine (or detect) whether one or more TCP connections have stalled as well as the requests on these TCP connections that have not completed. The operations in determination block 402 may be similar to those of determination block 356 described with reference to FIG. 3B, except that the operations of determination block 402 may return a plurality of stalled TCP connections for use in the operational loop shown in FIG. 4. In response to determining that no missing request(s) are identified on stalled TCP connection(s) based on the monitoring (i.e., determination block 402=“No”), the processor of the computing device may wait a period in optional block 378 as described with reference to FIG. 3B, and continue monitoring of the TCP connections.

In response to determining that missing request(s) are identified on stalled TCP connection(s) based on the monitoring (i.e., determination block 402=“Yes”), the processor of the computing device may generate an ordered list of the stalled TCP connection(s) determined to have missing request(s) based on predefined criteria in block 404, such as predefined priority information related to the TCP connection(s), the request(s), and/or other information. For example, the ordering may be based on age of the missing requests, importance, place within a group of segments (e.g., video segments that are played in a sequence), etc. In block 406, the processor of the computing device may set a next TCP connection in the ordered list as a next stalled TCP connection for use in the operations of blocks 358-376 as described in FIG. 3B. For example, the first time the operations in block 406 are performed for a particular ordered list, the stalled TCP connection may be the first TCP connection in the ordered list. The computing device may then perform the operations of blocks 358-376 as described with reference to FIG. 3B. In other words, the computing device may perform operations to identify a new network interface and/or a new data source to configure a new TCP connection for reissuing the missing request of current stalled TCP connection.

In response to performing the operations of blocks 358-376 of FIG. 3B, in determination block 408, the processor of the computing device may determine whether there are more stalled TCP connections in the ordered list. In response to determining there are no more stalled TCP connections in the ordered list (i.e., determination block 408=“No”), the processor of the computing device may wait a period in optional block 378 as described with reference to FIG. 3B, and continue monitoring of the TCP connections. In response to determining there are more stalled TCP connections in the ordered list (i.e., determination block 408=“Yes”), the computing device may set a new stalled TCP connection as the next TCP connection in the ordered list, performing operations in blocks 358-376 as described above until all missing requests on stalled TCP connections in the ordered list have been reissued in order.

FIG. 5 illustrates an embodiment method 500 for a computing device to cancel stalled TCP connections based on completion of requests by new TCP connections. The operations of method 500 may be considered as optional operations to be performed during the performance of the methods 350 or 400 as described above. In other words, instead of performing the operations of optional block 376 of the method 350 in response to performing the operations of block 374, the computing device may perform the operations of the method 500, which may also include the selective execution of the operations of block 376. Similar to as described above, the operations of the method 500 may be performed by the processor of the computing device, and further may be handled via various modules, logic, software, instructions, and operations executed by the processor (e.g., the modules 202-206 described with reference to FIGS. 2A-2E).

After performing the reissuing operations of block 374 as described above (e.g., re-issuing a stalled request on a new TCP connection via the method 350 or the method 400), in determination block 502 the processor of the computing device may determine whether the missing request has completed. In other words, the computing device may determine whether a requested data block, chunk, or other information that was previously missing due to its original TCP connection being stalled has been received via the original TCP connection or a new TCP connection (i.e., the re-issue of the request). In response to determining that the missing request has not yet completed (i.e., determination block 502=“No”), the computing device may continue to perform the operations of determination block 502. In some embodiments, in response to determining that the missing request has not yet completed (i.e., determination block 502=“No”), the computing device may proceed to perform the operations in block 376 for cancelling the stalled TCP connection (i.e., the original TCP connection for the stalled request), optionally waiting a period in optional block 378 in FIG. 3B, and then continuing to monitor TCP connections in block 354 in FIG. 3B. In this way, when the missing request has not completed, the computing device may cancel the original stalled TCP connection and simply monitor the new TCP connection for the missing request as described with reference to FIG. 3B.

In response to determining that the missing request has completed (i.e., determination block 502=“Yes”), the processor of the computing device may determine whether the stalled TCP connection completed the missing request before the new TCP connection completed the missing request in determination block 504. In response to determining that the missing request was completed on the stalled (or original) TCP connection before the new TCP connection (i.e., determination block 504=“Yes”), the processor of the computing device may cancel the new TCP connection in block 506. In other words, the stalled TCP connection (or original TCP connection) may have recovered from its stalled state faster than the new TCP connection was able to complete the missing request. In response to determining that the missing request was completed on the new TCP connection before the stalled TCP connection (i.e., determination block 504=“No”), the computing device may canceled the stalled TCP connection in block 376 as described with reference to FIG. 3B. The computing device may then perform the waiting operations in optional block 378 in FIG. 3B.

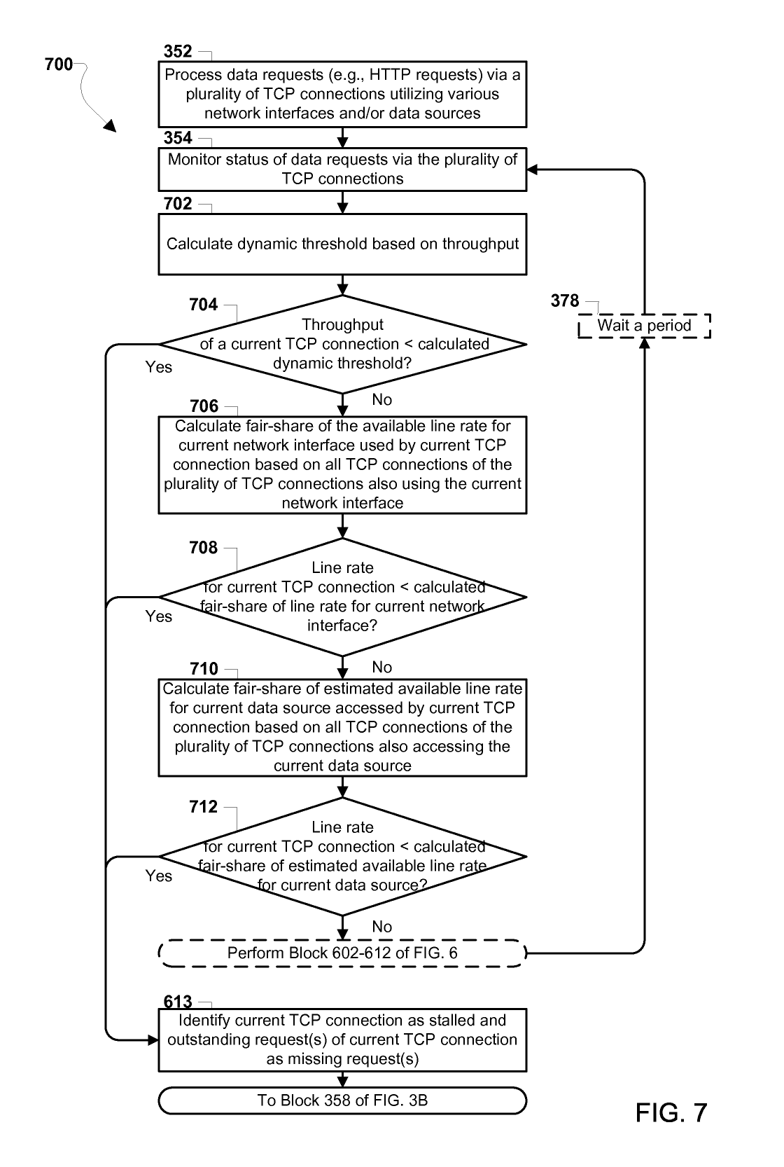

FIG. 6 illustrates another embodiment method 600 for a computing device to reissue requests (e.g., HTTP requests) of TCP connections identified as missing based on static thresholds on new TCP connections configured based on data related to other TCP connections utilized by the computing device. The method 600 may be similar to the method 350 described with reference to FIG. 3B, except that the method 600 may include operations for evaluating various thresholds to determine whether a TCP connection has stalled. Similar to as described above, the operations of the method 600 may be performed by the processor of the computing device, and further may be handled via various modules, logic, software, instructions, and operations executed by the processor (e.g., the modules 202-206 described with reference to FIGS. 2A-2E). Further, it should be appreciated that any combination and/or order of the following determinations may be used by the computing device to determine whether a TCP connection has stalled and thus whether a request should be reissued on a new TCP connection. It should be appreciated that the operations of method 600, particularly the operations of blocks 602-613, may be performed for each of the plurality of TCP connections such that each individual TCP connection is evaluated as being stalled or not. In other words, once the “current TCP connection” has been evaluated, the computing device may continue in a loop to evaluate all other TCP connections.

The operations of blocks 352-354 are similar to as described with reference to FIG. 3B. Based on the monitoring operations of block 354, in determination block 602, the processor of the computing device may determine whether a time to setup for a current TCP connection is greater than a predefined threshold. In response to determining that the time to setup the current TCP connection is not greater than the predefined threshold (i.e., determination block 602=“No”), the processor of the computing device may determine whether a time since a most recent successful reception/activity on the current TCP connection is greater than a predefined threshold in determination block 604. In response to determining that the time since the most recent successful reception/activity on the current TCP connection is not greater than a predefined threshold (i.e., determination block 604=“No”), the processor of the computing device may determine whether a throughput for the current TCP connection is less than a predefined threshold in determination block 606. In response to determining that the throughput is not less than the predefined threshold (i.e., determination block 606=“No”), the processor of the computing device may determine whether a roundtrip time for the current TCP connection is greater than a predefined threshold in determination block 608. In response to determining that the roundtrip time for the current TCP connection is not greater than a predefined threshold (i.e., determination block 608=“No”), the processor of the computing device may determine whether an estimate of a congestion window used by the current TCP connection is less than a threshold value in determination block 610. In general, when a congestion window for a TCP connection is high (or has a high value), the TCP connection is doing well and is not stalled. When the congestion window of the TCP connection is low, the TCP connection may be inferred as stalling. In response to determining that the estimate of the congestion window used by the current TCP connection is not less than the threshold value (i.e., determination block 610=“No”), the processor of the computing device may determine whether a lower layer recovery mechanism failed for the current TCP connection in determination block 612. In response to determining the lower layer recovery mechanism did not fail for the current TCP connection (i.e., determination block 612=“No”), the computing device may continue with the waiting operations of optional block 378 as described above and then may perform monitoring operations in block 354. In other words, the computing device may continue monitoring when no stalled requests (or TCP connection) are detected with the various determinations described above.

However, in response to determining that the time to setup the current TCP connection is greater than the predefined threshold (i.e., determination block 602=“Yes”), or in response to determining that the time since the most recent successful reception/activity on the current TCP connection is greater than a predefined threshold (i.e., determination block 604=“Yes”), or in response to determining that the throughput is less than the predefined threshold (i.e., determination block 606=“Yes”), or in response to determining that the roundtrip time for the current TCP connection is greater than a predefined threshold (i.e., determination block 608=“Yes”), or in response to determining that the estimate of the congestion window used by the current TCP connection is less than a threshold value (i.e., determination block 610=“Yes”), or in response to determining the lower layer recovery mechanism did fail for the current TCP connection (i.e., determination block 612=“Yes”), the computing device may identify the current TCP connection as stalled and identify all outstanding request(s) of the current TCP connection as missing request(s) in block 613. The computing device may then perform operations for reissuing the stalled request of the current, stalled TCP connection on a new TCP connection as described above with reference to blocks 358-376 of FIG. 3B. In other words, the computing device may reissue missing requests on a new TCP connection when the TCP connection is identified as stalled with the various determinations described above.

FIG. 7 illustrates another embodiment method 700 for a computing device to reissue requests (e.g., HTTP requests) of TCP connections identified as stalled based on dynamic information on new TCP connections configured based on data related to other TCP connections utilized by the computing device. The method 700 may be similar to the methods 350 or 600 described with reference to FIG. 3B or FIG. 6, except that the method 700 may include operations for evaluating various dynamic thresholds to determine whether a TCP connection has stalled. In other words, instead of utilizing static thresholds to compare against information gathered regarding TCP connections to detect stalls (e.g., throughput, etc.), the computing device may be configured to generate on-the-fly thresholds that also may be based on the recent experiences and characteristics of the various TCP connections of the computing device. Similar to as described above, the operations of the method 700 may be performed by the processor of the computing device, and further may be handled via various modules, logic, software, instructions, and operations executed by the processor (e.g., the modules 202-206 described with reference to FIGS. 2A-2E). It should be appreciated that the operations of method 700, particularly the operations of blocks 704-712, may be performed for each of the plurality of TCP connections such that each individual TCP connection is evaluated as being stalled or not. In other words, once the “current TCP connection” has been evaluated, the computing device may continue in a loop to evaluate all other TCP connections.

The operations of blocks 352-354 are similar to as described with reference to FIG. 3B. Based on the monitoring operations of block 354, the processor of the computing device may calculate a dynamic threshold based on throughput in block 702. For example, the dynamic threshold may be an average throughput experienced by a current TCP connection or a plurality of TCP connections over a period. In this way, the computing device may compare a particular TCP connection's current throughput to an up-to-date throughput threshold to determine a stall. In determination block 704, the processor of the computing device may determine whether the current throughput for a current TCP connection is less than the calculated dynamic threshold. In response to determining that the throughput for the current TCP connection is not less than the calculated dynamic threshold (i.e., determination block 704=“No”), the processor of the computing device may calculate a fair-share of an estimated available line rate for a current network interface used by the current TCP connection based on all TCP connections of the plurality of TCP connections that are also using the current network interface in block 706. As the line rate of the current network interface may be shared by multiple TCP connections, the throughput or download rate of the current TCP connection may be less than a best available line rate for the whole interface when there are other TCP connections to share the line rate, regardless of whether the current TCP connection is stalling. So, the calculated fair-share may indicate an amount relative to the usage of the TCP connection at a given time. In determination block 708, the processor of the computing device may determine whether the line rate (or download rate) for the current TCP connection is less than the calculated fair-share of the estimated available line rate for the current network interface. In response to determining that the line rate (or download rate) for the current TCP connection is not less than the calculated fair-share of the estimated available line rate for the current network interface (i.e., determination block 708=“No”), the processor of the computing device may calculate a fair-share of an estimated available line rate for a current data source accessed by the current TCP connection based on all TCP connections of the plurality of TCP connections also accessing the current data source in block 710. This operation in block 710 may be similar to the operation in block 706 except the calculation addresses a fair-share of an available line rate related to a data source instead of a network interface. In determination block 712, the processor of the computing device may determine whether the line rate (or download rate) for the current TCP connection is less than the calculated fair-share of the estimated available line rate for the current data source. In response to determining that the line rate (or download rate) for the current TCP connection is not less than the calculated fair-shared of the estimated available line rate for the current data source (i.e., determination block 712=“No”), the computing device may optionally perform the operations of blocks 602-612 described with reference to FIG. 6 to perform further determinations as to whether the current TCP connection is stalled using predefined thresholds. The computing device may then perform the waiting operations in optional block 378 and continue with the monitoring operations in block 354.

In response to determining that the throughput for the current TCP connection is less than the calculated dynamic threshold (i.e., determination block 704=“Yes”), or in response to determining that the line rate (or download rate) for the current TCP connection is less than the calculated fair-share of the estimated available line rate (e.g., an estimated portion of the line rate that is available for a single TCP connection) for the current network interface (i.e., determination block 708=“Yes”), or in response to determining that the line rate (or download rate) for the current TCP connection is less than the calculated, fair-shared of the estimated available line rate for the current data source (i.e., determination block 712=“Yes”), the computing device may identify the current TCP connection as stalled and identify the outstanding request(s) of current TCP connection as missing request(s) in block 613. The computing device may then perform the operations in block 358 as described with reference to FIG. 3B to begin operations for reissuing the stalled request on a new TCP connection.

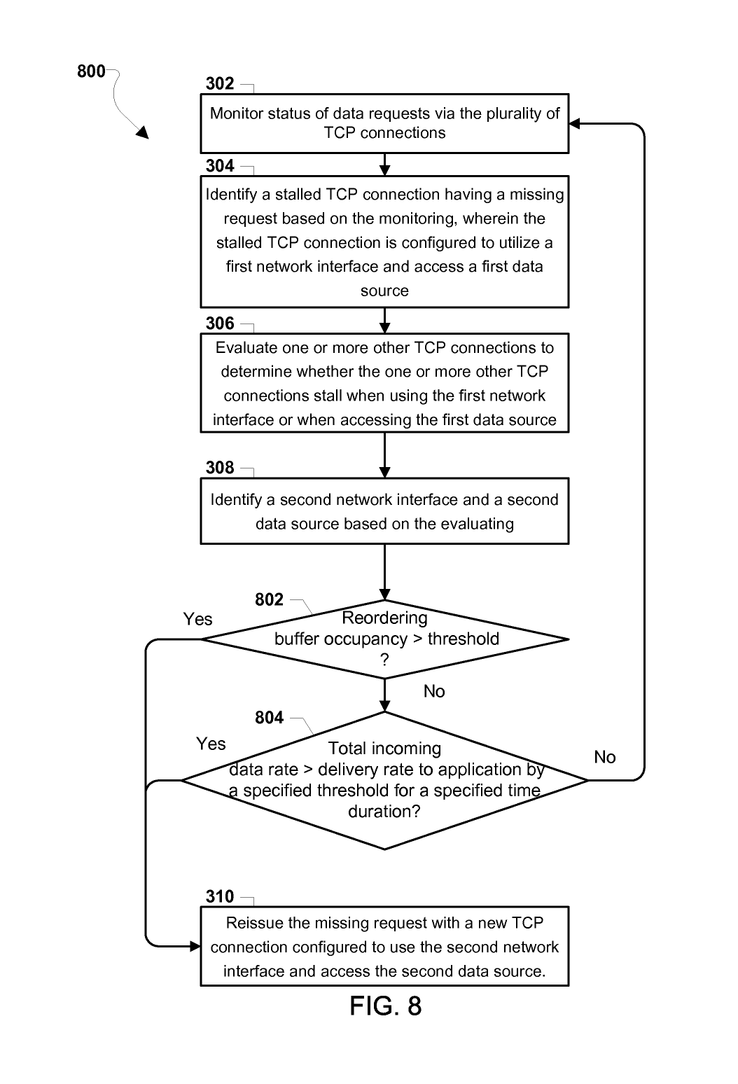

FIG. 8 illustrates an embodiment method 800 for a computing device to reissue requests (e.g., HTTP requests) of TCP connections based on reordering buffer occupancy and/or delivery rates to applications. The method 800 is similar to the method 300, except that the method 800 includes additional operations for evaluating data related to reordering buffers and/or delivery rates to applications (or egress rates) in order to determine whether to reissue requests. The operations of method 800 may be performed by the processor of the computing device, and further may be handled via various modules, logic, software, instructions, and operations executed by the processor (e.g., the modules 202-206 described with reference to FIGS. 2A-2E).

The operations of blocks 302-308, and 310 may include operations as described above with reference to FIG. 3A. In determination block 802, the processor of the computing device may determine whether a reordering buffer occupancy exceeds an occupancy threshold. As described above, in some embodiments, such a determination may be based on an estimate of how high the reordering buffer occupancy will grow before the request on the slow TCP connection is completed. The estimated occupancy may be compared with a fixed threshold that may depend on the buffer size limit. Alternately, the estimated occupancy may be compared with the corresponding estimate when the request is retried on a different connection or using a different networking interface; the option which gives the lowest estimate may be selected. These estimates of the buffer occupancy may be calculated based on the current reordering buffer occupancy, round-trip time, average rate of the slow TCP connection, the rates of the other TCP connections and the expected rate of the retried request on the new TCP connection.

In response to determining that the reordering buffer occupancy does not exceed the occupancy threshold (i.e., determination block 802=“No”), the processor of the computing device may determine whether a total incoming data rate (or ingress rate) exceeds a delivery rate to an application (or egress rate) by a specified threshold for a specified time duration in determination block 804. As described above, an additional input to deciding whether to retry a request (i.e., whether a TCP connection is stalled) may be based on whether the delivery rate to application (or egress rate) is less than the ingress rate by a specified threshold for a specified duration. For example, if a TCP connection is stalled, but the delivery rate to application (or egress rate) is comparable to the ingress rate, the stalled connection may be considered not yet the head-of-line and not blocking the delivery of bytes. Accordingly, there may be no need to retry the request on that TCP connection yet. However, if the delivery rate to application (or egress rate) is much lower than the ingress rate, this may increase the confidence in the decision to retry a request in addition to looking at the progress metrics of each TCP connection. Optionally, the computing device may identify and exclude the case where the delivery rate to application (or egress rate) is limited because of the application not reading bytes fast enough.

In response to determining that the total incoming data rate does not exceed the delivery rate to the application by the specified threshold for the specified time duration (i.e., determination block 804=“No”), the computing device may continue with the monitoring operations in block 302. In response to the computing device determining that the reordering buffer occupancy does exceed the occupancy threshold (i.e., determination block 802=“Yes”) or in response to the computing device determining that the total incoming data rate does exceed the delivery rate to the application by the specified threshold for the specified time duration (i.e., determination block 804=“Yes”), the computing device may perform the reissue operations in block 310.

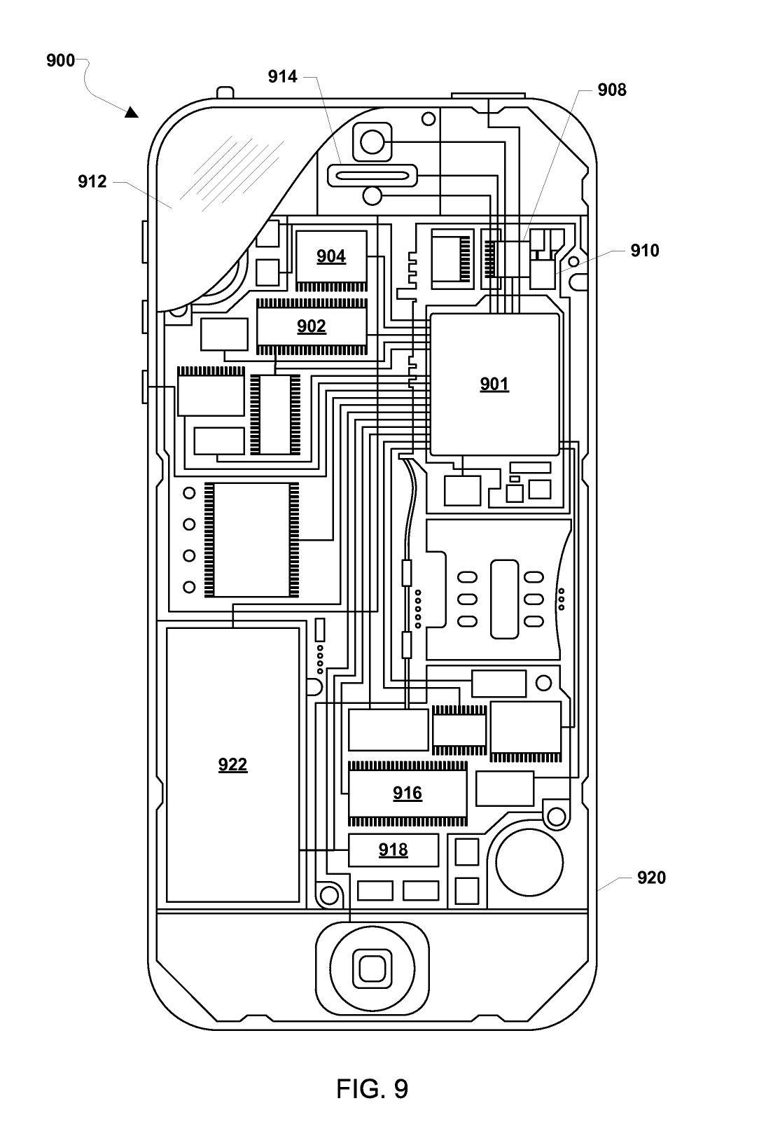

Various forms of computing devices, including personal computers and laptop computers, may be used to implement the various embodiments (such as those illustrated in FIGS. 3A, 3B, and 4-8) and typically include the components illustrated in FIG. 9 which illustrates an example smartphone mobile computing device 900. In various embodiments, the mobile computing device 900 may include a processor 901 coupled to a touch screen controller 904 and an internal memory 902. The processor 901 may be one or more multicore integrated circuits (ICs) designated for general or specific processing tasks. The internal memory 902 may be volatile or non-volatile memory, and may also be secure and/or encrypted memory, or unsecure and/or unencrypted memory, or any combination thereof. The touch screen controller 904 and the processor 901 may also be coupled to a touch screen panel 912, such as a resistive-sensing touch screen, capacitive-sensing touch screen, infrared sensing touch screen, etc. The mobile computing device 900 may have be configured with one or more network interfaces as well as one or more radio signal transceivers 908 (e.g., Bluetooth®, ZigBee®, Wi-Fi®, RF radio) and antennae 910, for sending and receiving, coupled to each other and/or to the processor 901. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor. The mobile computing device 900 may include a peripheral device connection interface 918 coupled to the processor 901. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown). The mobile computing device 900 may also include speakers 914 for providing audio outputs. The mobile computing device 900 may also include a housing 920, constructed of a plastic, metal, or a combination of materials, for containing all or some of the components discussed herein. The mobile computing device 900 may include a power source 922 coupled to the processor 901, such as a disposable or rechargeable battery. The rechargeable battery may also be coupled to the peripheral device connection port to receive a charging current from a source external to the mobile computing device 900.

The various processors described herein may be any programmable microprocessor, microcomputer or multiple processor chip or chips that can be configured by software instructions (applications) to perform a variety of functions, including the functions of the various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The steps of a method or algorithm disclosed herein may be embodied in a processor-executable software module or processor-executable software instructions which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A non-transitory computer-readable storage medium having stored thereon processor-executable instructions configured to cause a processor of a computing device to perform operations comprising:
monitoring a status of requests via a plurality of TCP connections;
identifying a stalled TCP connection having a missing request based on the monitoring, wherein the stalled TCP connection is configured to utilize a first network interface and access a first data source;
evaluating one or more other TCP connections to determine whether the one or more other TCP connections stall when using the first network interface or when accessing the first data source;
identifying a second network interface and a second data source based on the evaluating; and
reissuing the missing request with a new TCP connection configured to use the second network interface and access the second data source.

2. The non-transitory computer-readable storage medium of claim 1, wherein the stored processor-executable instructions are configured to cause the processor of the computing device to perform operations such that identifying the stalled TCP connection having the missing request based on the monitoring comprises:
identifying a current TCP connection as stalled and a request of the current TCP connection as missing based on one or more of:
determining a first time to setup for the current TCP connection is greater than a first threshold;
determining a second time since a most recent successful reception on the current TCP connection is greater than a second threshold;
determining a throughput for the current TCP connection is less than a third threshold;
determining a roundtrip time for the current TCP connection is greater than a fourth threshold;
determining an estimate of a congestion window used by the current TCP connection is less than a fifth threshold; or
determining a lower layer recovery mechanism failed for the current TCP connection.

3. The non-transitory computer-readable storage medium of claim 1, wherein the stored processor-executable instructions are configured to cause the processor of the computing device to perform operations such that identifying the stalled TCP connection having the missing request based on the monitoring comprises:
identifying a current TCP connection as stalled and a request of the current TCP connection as missing based on one or more of:
determining a first download rate for the current TCP connection is less than a second dynamic threshold calculated based on a fair-share of an estimated available line rate for a first set of TCP connections of the plurality of TCP connections also using the first network interface; or
determining a second download rate for the current TCP connection is less than a third dynamic threshold calculated based on a fair-share of an estimated available line rate for a second set of TCP connections of the plurality of TCP connections also accessing the first data source.

4. The non-transitory computer-readable storage medium of claim 1, wherein the stored processor-executable instructions are configured to cause the processor of the computing device to perform operations such that evaluating the one or more other TCP connections to determine whether the one or more other TCP connections stall when using the first network interface or when accessing the first data source comprises:
identifying the one or more other TCP connections using the first network interface;
determining that the identified one or more other TCP connections are successful using the first network interface; and
identifying the second network interface to be the same as the first network interface in response to determining the identified one or more other TCP connections are successful using the first network interface.

5. The non-transitory computer-readable storage medium of claim 1, wherein the stored processor-executable instructions are configured to cause the processor of the computing device to perform operations such that evaluating the one or more other TCP connections to determine whether the one or more other TCP connections stall when using the first network interface or when accessing the first data source comprises:
identifying the one or more other TCP connections using the first network interface;
determining that the identified one or more other TCP connections are not successful using the first network interface; and
identifying the second network interface as a network interface different from the first network interface in response to determining the identified one or more other TCP connections are not successful using the first network interface.

6. The non-transitory computer-readable storage medium of claim 1, wherein the stored processor-executable instructions are configured to cause the processor of the computing device to perform operations such that evaluating the one or more other TCP connections to determine whether the one or more other TCP connections stall when using the first network interface or when accessing the first data source comprises:
identifying the one or more other TCP connections accessing the first data source;
determining that the identified one or more other TCP connections are successful accessing the first data source; and
identifying the second data source to be the same as the first data source in response to determining the identified one or more other TCP connections are successful accessing the first data source.

7. The non-transitory computer-readable storage medium of claim 1, wherein the stored processor-executable instructions are configured to cause the processor of the computing device to perform operations such that evaluating the one or more other TCP connections to determine whether the one or more other TCP connections stall when using the first network interface or when accessing the first data source comprises:
identifying the one or more other TCP connections accessing the first data source;
determining that the identified one or more other TCP connections are not successful accessing the first data source; and
identifying the second data source as a data source different from the first data source in response to determining the identified one or more other TCP connections are not successful accessing the first data source.

8. The non-transitory computer-readable storage medium of claim 1, wherein the stored processor-executable instructions are configured to cause the processor of the computing device to perform operations further comprising:
determining whether the one or more other TCP connections are successful accessing the second data source using the second network interface; and maintaining the stalled TCP connection in response to determining that the one or more other TCP connections are not successful accessing the second data source using the second network interface.

9. The non-transitory computer-readable storage medium of claim 1, wherein:
the stored processor-executable instructions are configured to cause the processor of the computing device to perform operations further comprising determining whether the one or more other TCP connections are successful accessing the second data source using the second network interface; and
the stored processor-executable instructions are configured to cause the processor of the computing device to perform operations such that reissuing the missing request with the new TCP connection configured to use the second network interface and access the second data source comprises reissuing the missing request with the new TCP connection in response to determining that the one or more other TCP connections are successful accessing the second data source using the second network interface.

10. The non-transitory computer-readable storage medium of claim 1, wherein the stored processor-executable instructions are configured to cause the processor of the computing device to perform operations such that the reissued missing request only requests data identified in the missing request that was not received.

11. The non-transitory computer-readable storage medium of claim 1, wherein the stored processor-executable instructions are configured to cause the processor of the computing device to perform operations further comprising generating an ordered list of stalled TCP connections with missing requests based on a predefined criteria,
wherein the stored processor-executable instructions are configured to cause the processor of the computing device to perform operations such that reissuing the missing request with the new TCP connection configured to use the second network interface and access the second data source comprises reissuing each of the missing requests on new TCP connections based on the generated ordered list.

12. The non-transitory computer-readable storage medium of claim 1, wherein the stored processor-executable instructions are configured to cause the processor of the computing device to perform operations further comprising cancelling the stalled TCP connection in response to reissuing the missing request with the new TCP connection.

13. The non-transitory computer-readable storage medium of claim 12, wherein the stored processor-executable instructions are configured to cause the processor of the computing device to perform operations such that cancelling the stalled TCP connection in response to reissuing the missing request with the new TCP connection comprises:
determining whether the missing request is completed via the stalled TCP connection before being completed via the new TCP connection; and
cancelling the stalled TCP connection in response to determining the missing request is completed via the new TCP connection before being completed via the stalled TCP connection.

14. The non-transitory computer-readable storage medium of claim 1, wherein the first network interface is different than the second network interface.

15. The non-transitory computer-readable storage medium of claim 1, wherein the first network interface is the same as the second network interface.

16. The non-transitory computer-readable storage medium of claim 1, wherein the first data source is different than the second data source.

17. The non-transitory computer-readable storage medium of claim 1, wherein the first data source is the same as the second data source.

18. The non-transitory computer-readable storage medium of claim 1, wherein the stored processor-executable instructions are configured to cause the processor of the computing device to perform operations such that reissuing the missing request with the new TCP connection configured to use the second network interface and access the second data source comprises:
determining whether a reordering buffer occupancy exceeds an occupancy threshold; and
reissuing the missing request with the new TCP connection in response to determining that the reordering buffer occupancy exceeds the occupancy threshold.

19. The non-transitory computer-readable storage medium of claim 1, wherein the stored processor-executable instructions are configured to cause the processor of the computing device to perform operations such that reissuing the missing request with the new TCP connection configured to use the second network interface and access the second data source comprises:
determining whether a total incoming data rate exceeds a delivery rate to an application by a specified threshold for a specified time duration; and
reissuing the missing request with the new TCP connection in response to determining that the total incoming data rate exceeds the delivery rate to the application by the specified threshold for the specified time duration.

20. A method for improving reception of data at a computing device, comprising:
monitoring, by a processor of the computing device, a status of requests via a plurality of TCP connections;
identifying, by the processor of the computing device, a stalled TCP connection having a missing request based on the monitoring, wherein the stalled TCP connection is configured to utilize a first network interface and access a first data source;
evaluating, by the processor of the computing device, one or more other TCP connections to determine whether the one or more other TCP connections stall when using the first network interface or when accessing the first data source;
identifying, by the processor of the computing device, a second network interface and a second data source based on the evaluating; and
reissuing, by the processor of the computing device, the missing request with a new TCP connection configured to use the second network interface and access the second data source.

21. The method of claim 20, wherein evaluating, by the processor of the computing device, the one or more other TCP connections to determine whether the one or more other TCP connections stall when using the first network interface or when accessing the first data source comprises:
identifying, by the processor of the computing device, the one or more other TCP connections using the first network interface;
determining, by the processor of the computing device, that the identified one or more other TCP connections are successful using the first network interface; and
identifying, by the processor of the computing device, the second network interface to be the same as the first network interface in response to determining the identified one or more other TCP connections are successful using the first network interface.

22. The method of claim 20, wherein evaluating, by the processor of the computing device, the one or more other TCP connections to determine whether the one or more other TCP connections stall when using the first network interface or when accessing the first data source comprises:
identifying, by the processor of the computing device, the one or more other TCP connections using the first network interface;
determining, by the processor of the computing device, that the identified one or more other TCP connections are not successful using the first network interface; and
identifying, by the processor of the computing device, the second network interface as a network interface different from the first network interface in response to determining the identified one or more other TCP connections are not successful using the first network interface.

23. The method of claim 20, wherein evaluating, by the processor of the computing device, the one or more other TCP connections to determine whether the one or more other TCP connections stall when using the first network interface or when accessing the first data source comprises:
identifying, by the processor of the computing device, the one or more other TCP connections accessing the first data source;
determining, by the processor of the computing device, that the identified one or more other TCP connections are successful accessing the first data source; and
identifying, by the processor of the computing device, the second data source to be the same as the first data source in response to determining the identified one or more other TCP connections are successful accessing the first data source.

24. The method of claim 20, wherein evaluating, by the processor of the computing device, the one or more other TCP connections to determine whether the one or more other TCP connections stall when using the first network interface or when accessing the first data source comprises:
identifying, by the processor of the computing device, the one or more other TCP connections accessing the first data source;
determining, by the processor of the computing device, that the identified one or more other TCP connections are not successful accessing the first data source; and
identifying, by the processor of the computing device, the second data source as a data source different from the first data source in response to determining the identified one or more other TCP connections are not successful accessing the first data source.

25. A computing device, comprising:
a processor configured with processor-executable instructions to perform operations comprising:
monitoring a status of requests via a plurality of TCP connections;
identifying a stalled TCP connection having a missing request based on the monitoring, wherein the stalled TCP connection is configured to utilize a first network interface and access a first data source;
evaluating one or more other TCP connections to determine whether the one or more other TCP connections stall when using the first network interface or when accessing the first data source;
identifying a second network interface and a second data source based on the evaluating; and
reissuing the missing request with a new TCP connection configured to use the second network interface and access the second data source.

26. The computing device of claim 25, wherein the processor is configured with processor-executable instructions to perform operations such that evaluating the one or more other TCP connections to determine whether the one or more other TCP connections stall when using the first network interface or when accessing the first data source comprises:
identifying the one or more other TCP connections using the first network interface;
determining that the identified one or more other TCP connections are successful using the first network interface; and
identifying the second network interface to be the same as the first network interface in response to determining the identified one or more other TCP connections are successful using the first network interface.

27. The computing device of claim 25, wherein the processor is configured with processor-executable instructions to perform operations such that evaluating the one or more other TCP connections to determine whether the one or more other TCP connections stall when using the first network interface or when accessing the first data source comprises:
identifying the one or more other TCP connections using the first network interface;
determining that the identified one or more other TCP connections are not successful using the first network interface; and
identifying the second network interface as a network interface different from the first network interface in response to determining the identified one or more other TCP connections are not successful using the first network interface.

28. The computing device of claim 25, wherein the processor is configured with processor-executable instructions to perform operations such that evaluating the one or more other TCP connections to determine whether the one or more other TCP connections stall when using the first network interface or when accessing the first data source comprises:
identifying the one or more other TCP connections accessing the first data source;
determining that the identified one or more other TCP connections are successful accessing the first data source; and
identifying the second data source to be the same as the first data source in response to determining the identified one or more other TCP connections are successful accessing the first data source.

29. The computing device of claim 25, wherein the processor is configured with processor-executable instructions to perform operations such that evaluating the one or more other TCP connections to determine whether the one or more other TCP connections stall when using the first network interface or when accessing the first data source comprises:
identifying the one or more other TCP connections accessing the first data source;
determining that the identified one or more other TCP connections are not successful accessing the first data source; and
identifying the second data source as a data source different from the first data source in response to determining the identified one or more other TCP connections are not successful accessing the first data source.

30. A computing device, comprising:
means for monitoring a status of requests via a plurality of TCP connections;
means for identifying a stalled TCP connection having a missing request based on the monitoring, wherein the stalled TCP connection is configured to utilize a first network interface and access a first data source;
means for evaluating one or more other TCP connections to determine whether the one or more other TCP connections stall when using the first network interface or when accessing the first data source;
means for identifying a second network interface and a second data source based on the evaluating; and
means for reissuing the missing request with a new TCP connection configured to use the second network interface and access the second data source.
